(19) United States
(12) Patent Application Publication
(10) Pub. No.: US 2026/0261758 A1
(43) Pub. Date: Sep. 3, 2026

(54) IMAGE PROCESSING METHOD AND IMAGE PROCESSING SYSTEM

(71) Applicant: Panasonic Intellectual Property Management Co., Ltd., Osaka (JP)

(72) Inventors: SATOSHI SATO, Kyoto (JP); MOTOKI YAKO, Osaka (JP); YUMIKO KATO, Osaka (JP)

(21) Appl. No.: 19/658,791

(22) Filed: Apr. 27, 2026

Related U.S. Application Data
(63) Continuation of application No. PCT/JP2024/040702, filed on Nov. 15, 2024.

(30) Foreign Application Priority Data
Nov. 29, 2023 (JP) 2023-201691

(51) Int. Cl. H04N 23/667; H04N 23/11; H04N 23/12; H04N 23/63

(52) U.S. Cl. CPC H04N 23/667; H04N 23/12; H04N 23/632; H04N 23/11

(57) ABSTRACT

An image processing method includes: acquiring a compressed image; switching between a viewing mode and a save mode; in the viewing mode, displaying a first image on a display device and deleting the first image after displaying the first image, the first image being either the compressed image or a display-processed image that is generated based on the compressed image and represented by information of three or fewer wavelength bands; and in the save mode, generating, based on the compressed image, a second image represented by information of four or more wavelength bands, and saving the second image to a recording medium.

### BACKGROUND

### 1. Technical Field

The present disclosure relates to an image processing method and so forth.

### 2. Description of the Related Art

It has been proposed to apply compressed sensing to hyperspectral cameras, that is, to reconstruct a hyperspectral image from a compressed image. The following documents relate to such a technology: International Publication No. WO2022/202236 (Patent Document 1); International Publication No. WO2021/192891 (Patent Document 2); International Publication No. WO2020/080045 (Patent Document 3); “Establishing a World-First Technology for Capturing Hyperspectral Images and Videos by Combining Meta-lens and AI with Ordinary Digital Cameras~Turning an “ordinary camera” into a “camera that can see the nature of things” through the fusion of optical technology and AI~″, online, Oct. 24, 2022, Nippon Telegraph and Telephone Corporation, search on Nov. 16, 2023, Internet <URL:

https://group.ntt/en/newsrelease/2022/10/24/221024a.html> (Non-Patent Document 1); and Ahasan Ahamed et.al., “Reconstruction-based spectroscopy using CMOS image sensors with random photon-trapping nanostructure per sensor”, Proc. SPIE 11971, High-Speed Biomedical Imaging and Spectroscopy VII, 1197106, Mar. 2, 2022 (Non-Patent Document 2).

### SUMMARY

However, the amount of computation for reconstructing, from a compressed image, an image represented by information of four or more wavelength bands, such as a hyperspectral image, is enormous. Thus, the processing load is high, and also power consumption and energy consumption are high.

One non-limiting and exemplary embodiment provides an image processing method and so forth capable of reducing the processing load related to reconstruction of images. This makes it possible to reduce the amount of computation of one or more computers that execute the image processing method. That is, the performance of the one or more computers that execute the image processing method is improved.

In one general aspect, the techniques disclosed here feature an image processing method including: acquiring a compressed image; switching between a viewing mode and a save mode; in the viewing mode, displaying a first image on a display device and deleting the first image after displaying the first image, the first image being either the compressed image or a display-processed image that is generated based on the compressed image and represented by information of three or fewer wavelength bands; and in the save mode, generating, based on the compressed image, a second image represented by information of four or more wavelength bands, and saving the second image to a recording medium.

The image processing method according to an aspect of the present disclosure and so forth make it possible to reduce the processing load related to reconstruction of images.

It should be noted that general or specific embodiments may be implemented as a system, a device, a method, an integrated circuit, a computer program, a non-transitory recording medium such as a computer-readable compact disc read-only memory (CD-ROM), or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram illustrating a configuration example of an image processing system according to an embodiment;

FIG. 2 is a conceptual diagram illustrating a configuration example of an imaging device according to the embodiment;

FIG. 3 is a conceptual diagram illustrating a configuration example of a filter array according to the embodiment;

FIG. 4 is a graph illustrating an example of the transmission spectrum of a filter according to the embodiment;

FIG. 5 is a graph illustrating an example of the transmission spectrum of another filter according to the embodiment;

FIG. 6 is a schematic diagram illustrating an example of the transmittance of a first wavelength band of the filter array according to the embodiment;

FIG. 7 is a schematic diagram illustrating an example of the transmittance of a second wavelength band of the filter array according to the embodiment;

FIG. 8 is a flowchart illustrating an operation example of the image processing system according to the embodiment;

FIG. 9 is a conceptual diagram illustrating an operation example of the image processing system according to the embodiment;

FIG. 10 is an explanatory diagram illustrating an example of combinations of the type of image to be displayed and the type of image to be saved according to the embodiment;

FIG. 11 is a conceptual diagram illustrating a first display example according to the embodiment;

FIG. 12 is an explanatory diagram illustrating the relationship among a display button, a save button, and a mode according to the embodiment;

FIG. 13 is a flowchart illustrating a first specific example of the operation of the image processing system according to the embodiment;

FIG. 14 is a flowchart illustrating a second specific example of the operation of the image processing system according to the embodiment;

FIG. 15 is an explanatory diagram illustrating the relationship between four or more wavelength bands and three wavelength bands according to the embodiment;

FIG. 16 is a flowchart illustrating a third specific example of the operation of the image processing system according to the embodiment;

FIG. 17 is a flowchart illustrating a fourth specific example of the operation of the image processing system according to the embodiment;

FIG. 18 is a flowchart illustrating a fifth specific example of the operation of the image processing system according to the embodiment;

FIG. 19 is a flowchart illustrating a sixth specific example of the operation of the image processing system according to the embodiment;

FIG. 20 is a flowchart illustrating a seventh specific example of the operation of the image processing system according to the embodiment;

FIG. 21 is a flowchart illustrating an eighth specific example of the operation of the image processing system according to the embodiment;

FIG. 22 is a diagram illustrating an example of data f indicating a reconstructed image of three wavelength bands according to the embodiment;

FIG. 23 is a diagram illustrating an example of a matrix H corresponding to mask data of three wavelength bands according to the embodiment;

FIG. 24 is a diagram illustrating an example of data f indicating a low-resolution reconstructed image of three wavelength bands according to the embodiment;

FIG. 25 is a diagram illustrating an example of a matrix H corresponding to low-resolution mask data of three wavelength bands according to the embodiment;

FIG. 26 is a flowchart illustrating a ninth specific example of the operation of the image processing system according to the embodiment;

FIG. 27 is a conceptual diagram illustrating a second display example according to the embodiment;

FIG. 28 is a conceptual diagram illustrating a third display example according to the embodiment;

FIG. 29 is a conceptual diagram illustrating a fourth display example according to the embodiment;

FIG. 30 is a flowchart illustrating a tenth specific example of the operation of the image processing system according to the embodiment;

FIG. 31 is a flowchart illustrating an eleventh specific example of the operation of the image processing system according to the embodiment;

FIG. 32 is a diagram illustrating an example of the relationship between first pixels included in an image sensor and first pixel values, and the relationship between the first pixels included in the image sensor and second pixel values; and

FIG. 33 is a diagram illustrating an example of an image I₂ₗ, . . . , and an image I_{2w}.

### DETAILED DESCRIPTIONS

For example, an RGB camera detects light and generates an RGB image represented by information of three wavelength bands corresponding to red, green, and blue. On the other hand, a hyperspectral camera detects light and generates a hyperspectral image represented by information of four or more wavelength bands. Hyperspectral cameras and hyperspectral images have been utilized in various fields, such as food inspection, biopsy, medical drug development, and mineral component analysis.

From the viewpoint of cost and flexibility, it has been proposed to apply compressed sensing to hyperspectral cameras, that is, to reconstruct a hyperspectral image from a compressed image. A compressed image herein is, for example, an image having pieces of information of four or more wavelength bands superimposed one on another. A hyperspectral image can be reconstructed from a compressed image in accordance with sparsity.

However, the amount of computation for reconstructing, from a compressed image, an image represented by information of four or more wavelength bands, such as a hyperspectral image, is enormous. Thus, the processing load is high, and also power consumption and energy consumption are high.

An image processing method of Example 1 includes: acquiring a compressed image; switching between a viewing mode and a save mode; in the viewing mode, displaying a first image on a display device and deleting the first image after displaying the first image, the first image being either the compressed image or a display-processed image that is generated based on the compressed image and represented by information of three or fewer wavelength bands; and in the save mode, generating, based on the compressed image, a second image represented by information of four or more wavelength bands, and saving the second image to a recording medium.

This makes it possible to, when saving is not performed, omit generation of the second image represented by information of four or more wavelength bands. Thus, it is possible to reduce the processing load, and reduce power consumption and energy consumption.

An image processing method of Example 2 may be an image processing method according to the image processing method of Example 1, in which the first image is the compressed image.

This makes it possible to display the compressed image as it is in the viewing mode. Thus, it is possible to further reduce the processing load.

An image processing method of Example 3 may be an image processing method according to the image processing method of Example 1, in which the first image is the display-processed image.

This makes it possible to generate the first image suitable for display with a small amount of computation in the viewing mode. Thus, it is possible to display the first image suitable for display, while reducing the processing load.

An image processing method of Example 4 may be an image processing method according to the image processing method of Example 3, in which the first image is an RGB image represented by information of three wavelength bands.

This makes it possible to generate the RGB image as the first image in the viewing mode. Thus, it is possible to display the first image more suitable for display.

An image processing method of Example 5 may be an image processing method according to the image processing method of Example 3, in which the first image is a monochrome image represented by information of one wavelength band.

This makes it possible to generate the monochrome image as the first image in the viewing mode. Thus, it is possible to further reduce the processing load.

An image processing method of Example 6 may be an image processing method according to the image processing method of any one of Examples 3 to 5, in which the first image has a lower resolution than the second image.

This makes it possible to generate the first image having a low resolution in the viewing mode. Thus, it is possible to further reduce the processing load.

An image processing method of Example 7 may be an image processing method according to the image processing method of any one of Examples 3 to 6, in which, in acquisition of the compressed image, the compressed image is acquired through light receiving regions having transmission spectra, in generation of the first image, the first image is generated based on the compressed image and first mask data that includes values reflecting the transmission spectra, in generation of the second image, the second image is generated based on the compressed image and second mask data that includes values reflecting the transmission spectra, and the values included in the first mask data are fewer than the values included in the second mask data.

This makes it possible to generate, in the viewing mode, the first image by using the first mask data that includes a smaller number of values than the second mask data used for generating the second image. Thus, it is possible to further reduce the processing load.

An image processing method of Example 8 may be an image processing method according to the image processing method of any one of Examples 1 to 7, in which the switching between the viewing mode and the save mode is performed based on an operation performed by a user.

This makes it possible to adaptively switch between the viewing mode and the save mode. Thus, it is possible to adaptively reduce the processing load.

An image processing method of Example 9 may be an image processing method according to the image processing method of any one of Examples 1 to 7, further including: in the viewing mode, determining whether the first image includes a specific subject, in which, in the switching between the viewing mode and the save mode, the viewing mode is continued in response to a determination being made that the first image does not include the specific subject, and switching from the viewing mode to the save mode is performed in response to a determination being made that the first image includes the specific subject.

This makes it possible to switch between the viewing mode and the save mode in accordance with whether the first image includes the specific subject. When the first image includes the specific subject, it is possible to save the second image including the specific subject. Thus, it is possible to efficiently save the second image including the specific subject.

An image processing method of Example 10 may be an image processing method according to the image processing method of any one of Examples 1 to 9, further including: in the save mode, displaying the first image on the display device.

This makes it possible to display the first image in both the viewing mode and the save mode. Thus, it is possible to display the first image in the save mode continuously from the viewing mode.

An image processing method of Example 11 may be an image processing method according to the image processing method of Example 10, further including: in the save mode, saving the first image to the recording medium.

This makes it possible to save the displayed first image in the save mode. Thus, it is possible to save the displayed first image together with the second image in the save mode.

An image processing method of Example 12 may be an image processing method according to the image processing method of Example 10 or 11, further including: in the save mode, displaying one or both of the second image and an analysis result of a subject based on the second image.

This makes it possible to display information corresponding to the second image in the save mode. Thus, it is possible to display the first image and information corresponding to the second image in the save mode.

An image processing method of Example 13 may be an image processing method according to the image processing method of any one of Examples 3 to 6, further including: in the save mode, generating the first image, based on the second image generated based on the compressed image, and displaying the first image on the display device.

This makes it possible to display the first image in both the viewing mode and the save mode. Thus, it is possible to display the first image in the save mode continuously from the viewing mode. Furthermore, it is possible to efficiently generate the first image based on the second image in the save mode. Thus, in the save mode, an increase in the processing load is suppressed.

An image processing system of Example 14 includes: an image sensor that acquires a compressed image; and a processing circuit that switches between a viewing mode and a save mode, in which, in the viewing mode, the processing circuit displays a first image on a display device and deletes the first image after displaying the first image, the first image being either the compressed image or a display-processed image that is generated based on the compressed image and represented by information of three or fewer wavelength bands, and in the save mode, the processing circuit generates, based on the compressed image, a second image represented by information of four or more wavelength bands, and saves the second image to a recording medium.

This makes it possible to, when saving is not performed, omit generation of the second image represented by information of four or more wavelength bands. Thus, it is possible to reduce the processing load, and reduce power consumption and energy consumption.

A program of Example 15 is a program for causing a computer to execute the image processing method of any one of Examples 1 to 13.

This makes it possible to implement the program for causing the computer to execute the foregoing image processing method.

Furthermore, these general or specific embodiments may be implemented as a system, a device, a method, an integrated circuit, a computer program, a non-transitory recording medium such as a computer-readable compact disc read-only memory (CD-ROM), or any selective combination thereof.

Hereinafter, embodiments will be described with reference to the drawings. The embodiments described below each illustrate a general or specific example. The numerical values, shapes, materials, components, arrangement positions and connection manner of the components, steps, order of the steps, etc., illustrated in the following embodiments are merely examples and are not intended to limit the scope of the claims.

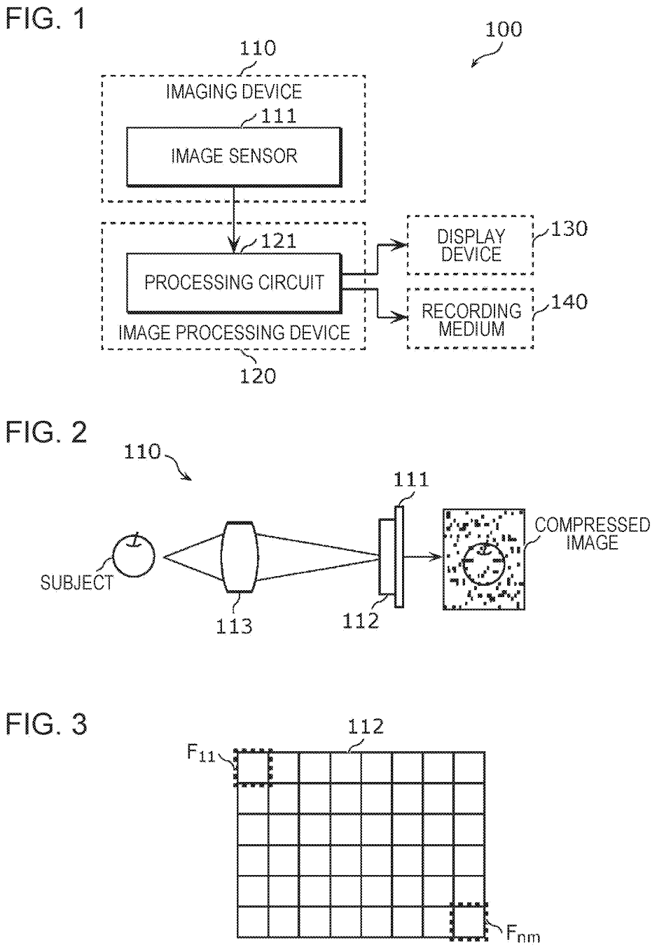

FIG. 1 is a block diagram illustrating a configuration example of an image processing system according to an embodiment. As illustrated in FIG. 1, an image processing system 100 includes an image sensor 111 and a processing circuit 121. The image processing system 100 may further include a display device 130 and a recording medium 140. The image processing system 100 may include an imaging device 110 and an image processing device 120. The imaging device 110 may include the image sensor 111. The image processing device 120 may include the processing circuit 121.

The image sensor 111 detects optical signals on a pixel-by-pixel basis and generates an image represented by the optical signals corresponding to pixels, thereby acquiring the image. Here, the image sensor 111 acquires a compressed image. Specifically, for example, the image sensor 111 acquires a compressed image in which pieces of information of four or more wavelength bands are superimposed one on another on a pixel-by-pixel basis in accordance with a filter array, which will be described below. The wavelength bands may be simply referred to as bands.

The image sensor 111 may be a monochrome photodetector including photodetection elements arranged in a matrix. More specifically, the image sensor 111 may be a charge-coupled device (CCD) image sensor, a complementary metal-oxide-semiconductor (CMOS) image sensor, an infrared-array image sensor, a terahertz-array image sensor, or a millimeter-wave-array image sensor.

Alternatively, the image sensor 111 may be a color photodetector. The wavelength range detectable by the image sensor 111 is not limited and may be, for example, visible light, ultraviolet light, infrared light, terahertz waves, or any combination thereof.

The processing circuit 121 is a circuit that performs information processing. For example, the processing circuit 121 executes reconstruction computation on a compressed image to generate a hyperspectral image represented by information of four or more wavelength bands. For example, the hyperspectral image is constituted by four or more spectral images corresponding to the four or more wavelength bands. The reconstruction computation may be the same as that described in Patent Documents 2 and 3. Specifically, four or more spectral images may be generated as a hyperspectral image, based on the following expression (1).

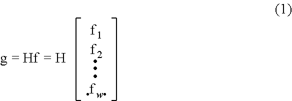

Here, g represents data indicating a compressed image, and is represented by, for example, a one-dimensional array (i.e., a vector). When the compressed image is an image having n×m pixels, the data g is represented by a one-dimensional array having n×m elements, f represents data indicating w spectral images corresponding one-to-one to w wavelength bands and is represented by, for example, a one-dimensional array. When the w spectral images constitute a hyperspectral image, w is an integer greater than or equal to 4.

f₁ represents data of a spectral image corresponding to a wavelength band W₁, f₂ represents data of a spectral image corresponding to a wavelength band W₂, . . . , and f_{w} represents data of a spectral image corresponding to a wavelength band Ww.

The data f₁, the data f₂, . . . , and the data f_{w} are each represented by, for example, a one-dimensional array. When each spectral image is an image having n×m pixels, the data f₁, the data f₂, . . . , and the data f_{w} are each represented by a one-dimensional array having n×m elements, and the data f is represented by a one-dimensional array having n×m×w elements. His a matrix of n×m rows and n×m×w columns, called a system matrix, and corresponds to mask data.

The matrix H may be determined based on the transmission spectrum of the wavelength band W₁, the transmission spectrum of the wavelength band W₂, . . . , and the transmission spectrum of the wavelength band Ww, of the filter array described below.

The data f satisfying expression (1) can be estimated by using a method of compressed sensing, and can specifically be estimated by using expression (2).

$$f = {arg min}_{f} \{ {‖ g - Hf ‖}_{2}^{2} + τΦ ( f ) \} \qquad ( 2 )$$

Expression (2) expresses calculating the data f that minimizes the sum of the first and second terms in the parentheses. The data f can be calculated as the data of a final computation result by converging the data of a computation result through recursive iterative computation.

The first term in the parentheses in expression (2) represents the sum of squared differences between data Hf, which is obtained by transforming the estimated data f with the matrix H, and the data g; this is a so-called residual term. While the sum of squares is used here, the sum of absolute values, the square root of the sum of squares, or the like may be used instead.

The sum of squared differences between the data Hf and the data g is expressed by (g₁−r₁)×(g₁−r₁)+ . . . +(g_{n×m}−r_{n×m})×(g_{n×m}−r_{n×m}). Here, g₁, . . . , and g_{n×m} are each an element of the data g expressed by g=(g₁ . . . g_{n×m})^{T}. Also, r₁, . . . , and r_{n×m} are each an element of the data Hf expressed by Hf=(r₁ . . . r_{n×m})^{T}.

The second term in the parentheses in expression (2) is a regularization term, which may be referred to as a stabilization term. Φ(f) represents the constraint in the regularization of f and is a function that reflects sparse information of the data f. This function has an effect of smoothing or stabilizing the data f. Φ(f) can be represented by, for example, discrete cosine transform (DCT), wavelet transform, Fourier transform, total variation (TV), or any combination thereof.

τ is a weighting coefficient of the regularization term and corresponds to the degree of influence of regularization in reconstruction computation. As the value of τ increases, the influence of regularization becomes stronger, and the convergence of the solution in iterative computation increases. Conversely, as the value of τ decreases, the influence of regularization becomes weaker, and the convergence of the solution in iterative computation decreases.

The display device 130 is a display for displaying information. On the display device 130, a compressed image, a monochrome image, an RGB image, a hyperspectral image, or the like is displayed by the processing circuit 121. The display device 130 may be, for example, a liquid crystal display (LCD), an organic electroluminescence (organic light-emitting diode (OLED)) display, or the like.

The display device 130 may display a graphical user interface (GUI). The display device 130 may be a touch screen. The display device 130 may receive information from a user. The processing circuit 121 may acquire information from a user via the display device 130. That is, the display device 130 may be an input/output device. Alternatively, the processing circuit 121 may acquire information from a user via an input device different from the display device 130.

The recording medium 140 is a storage element for storing information. To the recording medium 140, a compressed image, a monochrome image, an RGB image, a hyperspectral image, or the like is saved by the processing circuit 121. The recording medium 140 can be implemented by, for example, a compact disc read-only memory (CD-ROM), a hard disk drive, a solid-state drive, or the like.

FIG. 1 illustrates a configuration example of the image processing system 100. The configuration of the image processing system 100 is not limited to the configuration example in FIG. 1. For example, multiple devices may be integrated into a single device, or a single device may be implemented as multiple distributed devices. The multiple distributed devices may be capable of communicating with each other by wired or wireless communication.

The processing circuit 121 corresponds to an acquirer that acquires an image from the image sensor 111, a switcher that switches between modes, a generator that generates an image, a discard controller that discards an image, a display controller that displays an image on the display device 130, a save controller that saves an image to the recording medium 140, and so forth. Instead of the processing circuit 121, the image processing device 120 may include some or all of these components.

FIG. 2 is a conceptual diagram illustrating a configuration example of the imaging device 110 illustrated in FIG. 1. The imaging device 110 can have a configuration similar to those of the imaging devices disclosed in Patent Documents 2 and 3. For example, the imaging device 110 includes the image sensor 111, a filter array 112, and an optical system 113.

The filter array 112 is disposed on an optical path of light incident from a subject and is disposed between the optical system 113 and the image sensor 111. The filter array 112 functions as the encoding element described in Patent Document 2. The filter array 112 may be integrated with the image sensor 111.

The disposition of the filter array 112 is not limited to the disposition in FIG. 2. For example, the filter array 112 may be disposed away from the image sensor 111, between the optical system 113 and the image sensor 111. For example, the filter array 112 may be disposed between the subject and the optical system 113. For example, the filter array 112 may be disposed within the optical system 113.

The optical system 113 is disposed on an optical path of light incident from the subject and is disposed between the subject and the filter array 112. The optical system 113 includes at least one lens and is capable of forming an image of the subject on the imaging surface of image sensor 111 through the filter array 112.

The configuration and disposition of the optical system 113 are not limited to the configuration and disposition in FIG. 2. For example, the optical system 113 may be disposed between the filter array 112 and the image sensor 111. Furthermore, for example, the optical system 113 may include lenses arranged on the optical path. In this case, the filter array 112 may be disposed between adjacent lenses of these lenses.

FIG. 3 is a conceptual diagram illustrating a configuration example of the filter array 112 illustrated in FIG. 2. The filter array 112 includes filters F₁₁, . . . , and Fₙₘ arranged in a matrix. In the example illustrated in FIG. 3, the filter array 112 includes forty-eight filters F₁₁, . . . , and Fₙₘ arranged in six rows and eight columns. The filter F₁₁ is a filter disposed at the upper left of the forty-eight filters F₁₁, . . . , and Fₙₘ, and the filter Fₙₘ is a filter disposed at the lower right of the forty-eight filters F₁₁, . . . , and Fₙₘ.

The number of the filters F₁₁, . . . , and Fₙₘ included in the filter array 112 is not limited to forty-eight. For example, the number of the filters F₁₁, . . . , and Fₙₘ included in the filter array 112 may be equivalent to the number of the pixels of the image sensor 111, and can be determined in accordance with the application, for example, in the range from several tens to several tens of millions. The number of the filters F₁₁, . . . , and Fₙₘ included in the filter array 112 may be the same as or different from the number of the pixels of the image sensor 111. The pixels included in the image sensor 111 may correspond one-to-one to the filters F₁₁, . . . , and Fₙₘ.

For example, the filter array 112 includes n×m filters F₁₁, . . . , and Fₙₘ corresponding to n×m pixels. In the wavelength bands W₁, . . . , and Ww, the filters F₁₁, . . . , and Fₙₘ have transmission spectra S₁₁, . . . , and Sₙₘ, respectively. The transmission spectra S₁₁, . . . , and Sₙₘ may all be different. Alternatively, some of the transmission spectra S₁₁, . . . , and Sₙₘ may be the same. Here, the transmission spectrum can mean an optical transmittance spectrum.

The n×m filters F₁₁, . . . , and Fₙₘ have n×m×w transmittances S_{11W1}, . . . , and S_{nmWw} for the w wavelength bands W₁, . . . , and W_{w}. The transmittances S_{11W1}, . . . , and S_{nmWw} may all be different. Alternatively, some of the transmittances S_{11W1}, . . . , and S_{nmWw} may be the same. Here, the transmittance can mean optical transmittance.

The transmittance of a filter β in the wavelength band W_{α} may be expressed by the following expression (3).

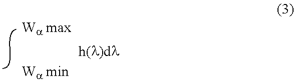

Here, Wαmin represents the minimum wavelength value of the wavelength band W_{α}, Wαmax is the maximum wavelength value of the wavelength band W_{α}, h(λ) represents a function indicating the transmission spectrum, and λ represents the wavelength.

The transmittance of the filter B in the wavelength band W_{α} is not limited to the one expressed by expression (3). For example, the transmittance of the filter β in the wavelength band W_{α} may be the transmittance obtained by dividing expression (3) by (Wαmax−Wαmin). For example, the transmittance of the filter β in the wavelength band W_{α} may be the transmittance h(λ_{α0}) in the wavelength λ_{α0} representing the wavelength band W_{α}.

Here, the wavelength λ_{α0} is a wavelength that satisfies Wαmin≤λ_{α0}<Wαmax. For example, the wavelength Ago may be the center wavelength of the wavelength band W_{α} ((Wαmax−Wαmin)/2).

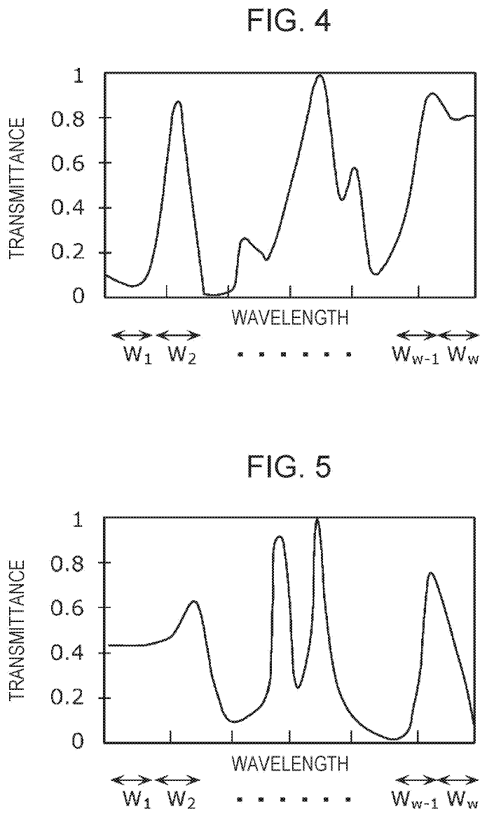

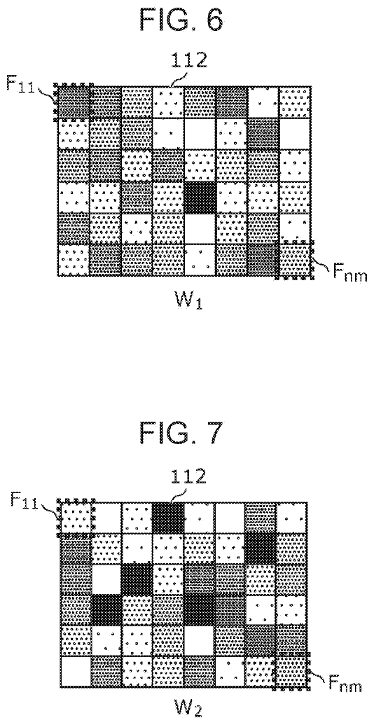

FIG. 4 illustrates an example of the transmission spectrum of the filter F₁₁ illustrated in FIG. 3. FIG. 5 illustrates an example of the transmission spectrum of the filter Fₙₘ illustrated in FIG. 3. FIG. 6 is a diagram illustrating an example of the transmittance of the wavelength band W₁ of the filter array 112 illustrated in FIG. 3. FIG. 7 is a diagram illustrating an example of the transmittance of the wavelength band W₂ of the filter array 112 illustrated in FIG. 3. In FIGS. 6 and 7, the shading in each region represents the transmittance of the filter, with lighter regions indicating higher transmittance and darker regions indicating lower transmittance.

The wavelength dependence of the transmittance varies among the filters F₁₁, . . . , and Fₙₘ included in the filter array 112. For example, in the filter F₁₁, the transmittance of the wavelength band W₁ is considerably lower than the transmittance of the wavelength band W₂. On the other hand, in the filter Fₙₘ, the transmittance of the wavelength band W₁ is substantially the same as the transmittance of the wavelength band W₂. In other words, the wavelength dependence of the transmittance of the filter F₁₁ is different from the wavelength dependence of the transmittance of the filter Fₙₘ.

Here, the illustration and description will be given of the transmittances of the two wavelength bands W₁ and W₂ of the w wavelength bands W₁, . . . , and W_{w}, and the illustration and description of the transmittances of the other wavelength bands will be omitted.

For example, mask data is represented by w matrices corresponding to the w wavelength bands W₁, W₂, . . . , and W_{w}. Specifically, mask data is represented by a transmittance matrix of n rows and m columns corresponding to pixels in n rows and m columns, for each of the w wavelength bands W₁, W₂, . . . , and W_{w}. As a result of changing a representation form from the mask data represented by w matrices each having n rows and m columns, one matrix H having n×m rows and n×m×w columns is obtained.

H included in expression (1) may be expressed by H=(H₁ H₂ . . . H_{w}). Each of H₁, H₂, . . . , and, H_{w} is a submatrix of H. That is, when the components included in H are expressed by a(11), . . . , and a ((n×m)(n×m×w)), the following expression holds.

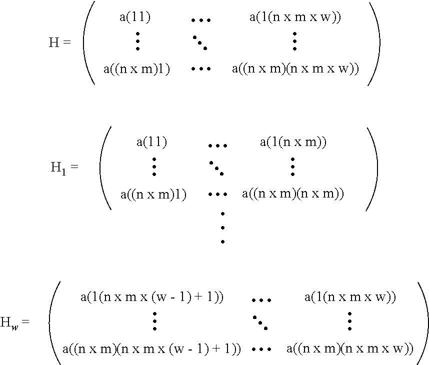

H₁ may be interpreted as the mask data for the wavelength band W₁, H₂ may be interpreted as the mask data for the wavelength band W₂, . . . , and H_{w} may be interpreted as the mask data for the wavelength band W_{w}.

Each of H₁, H₂, . . . , and H_{w} may be a diagonal matrix. That is, H₁, H₂, . . . , and H_{w} may be expressed as follows.

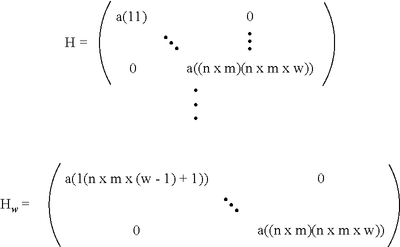

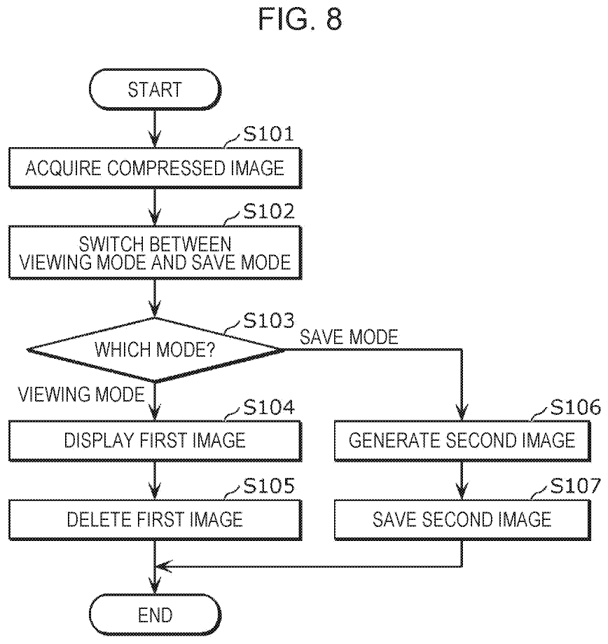

FIG. 8 is a flowchart illustrating an operation example of the image processing system 100 illustrated in FIG. 1. In this example, the image sensor 111 of the imaging device 110 generates a compressed image to acquire the compressed image, and the processing circuit 121 of the image processing device 120 acquires the compressed image from the image sensor 111 (S101). That is, the operation of acquiring a compressed image may correspond to the operation in which the image sensor 111 generates a compressed image to acquire the compressed image, or the operation in which the processing circuit 121 acquires the compressed image from the image sensor 111.

Subsequently, the processing circuit 121 switches between a viewing mode and a save mode (S102). Here, the processing circuit 121 may switch the mode from the viewing mode to the save mode, may switch the mode from the save mode to the viewing mode, may maintain the viewing mode, or may maintain the save mode.

In the viewing mode (viewing mode in S103), the processing circuit 121 displays a first image on the display device 130 (S104). Here, the first image may be the compressed image. Alternatively, the first image may be a display-processed image that is generated based on the compressed image and represented by information of three or fewer wavelength bands. After displaying the first image, the processing circuit 121 deletes the first image (S105).

In the save mode (save mode in S103), the processing circuit 121 generates a second image based on the compressed image (S106). The second image is an image represented by information of four or more wavelength bands. Subsequently, the processing circuit 121 saves the second image to the recording medium 140 (S107).

Accordingly, when saving is not performed, generation of the second image represented by information of four or more wavelength bands can be omitted. Thus, it is possible to reduce the processing load, and reduce power consumption and energy consumption.

For example, the above-described series of operations (S101 to S107) may be performed repeatedly. In the viewing mode, first images can be displayed as a video, and in the save mode, second images can be saved as a video.

For example, when the first image is a compressed image, the compressed image can be displayed as it is in the viewing mode. Thus, it is possible to further reduce the processing load.

For example, when the first image is a display-processed image, the processing circuit 121 may generate the first image based on the compressed image in the viewing mode. This makes it possible to generate the first image suitable for display with a small amount of computation in the viewing mode. Thus, it is possible to display the first image suitable for display, while reducing the processing load.

For example, the first image may be an RGB image represented by information of three wavelength bands. This makes it possible to generate the RGB image as the first image in the viewing mode. Thus, it is possible to display the first image more suitable for display.

For example, the first image may be a monochrome image represented by information of one wavelength band. This makes it possible to generate the monochrome image as the first image in the viewing mode. Thus, it is possible to further reduce the processing load.

For example, the first image may have a lower resolution than the second image. This makes it possible to generate the first image having a low resolution in the viewing mode. Thus, it is possible to further reduce the processing load.

For example, the image sensor 111 may acquire the compressed image through light receiving regions having transmission spectra. Specifically, the image sensor 111 may acquire the compressed image through the filter array 112. Each of the light receiving regions may correspond to a corresponding one of the filters included in the filter array 112.

Alternatively, the meta-lens described in Non-Patent Document 1 may be used instead of the filter array 112. In this case, the wavelength transmittance varies depending on a location. The light receiving region corresponds to such a location. Alternatively, the CMOS image sensor described in Non-Patent Document 2 may be used instead of the filter array 112. In this case, a sensing region is processed so that a predetermined transmittance is obtained in each pixel. The light receiving region corresponds to such a sensing region.

The light receiving region may be represented as an optical element, a modulation element, an encoding element, an optical processing region, a masking region, or the like.

The processing circuit 121 may generate the first image based on the compressed image and first mask data. Here, the first mask data includes values reflecting the transmission spectra. The processing circuit 121 may generate the second image based on the compressed image and second mask data. Here, the second mask data includes values reflecting the transmission spectra. The number of the values included in the first mask data is smaller than the number of the values included in the second mask data.

This makes it possible to generate, in the viewing mode, the first image by using the first mask data that includes a smaller number of values than the second mask data used for generating the second image. Thus, it is possible to further reduce the processing load.

For example, the first mask data may be generated in accordance with integration of the matrix elements of the second mask data or the like. This makes it possible to reduce the number of the values included in the first mask data. It is also possible to efficiently generate both the first mask data for generating the first image and the second mask data for generating the second image from the common transmission spectra. Thus, it is possible to reduce the number of calibrations.

For example, the processing circuit 121 may switch between the viewing mode and the save mode in accordance with an operation performed by a user. This makes it possible to adaptively switch between the viewing mode and the save mode. Thus, it is possible to adaptively reduce the processing load.

Furthermore, for example, the processing circuit 121 may determine, in the viewing mode, whether the first image includes a specific subject. In response to determining that the first image does not include the specific subject, the processing circuit 121 may continue the viewing mode. On the other hand, in response to determining that the first image includes the specific subject, the processing circuit 121 may switch the mode from the viewing mode to the save mode.

This makes it possible to switch between the viewing mode and the save mode in accordance with whether the first image includes the specific subject. When the first image includes the specific subject, it is possible to save the second image including the specific subject. Thus, it is possible to efficiently save the second image including the specific subject.

For example, the processing circuit 121 may display the first image on the display device 130 in the save mode. This makes it possible to display the first image in both the viewing mode and the save mode. Thus, it is possible to display the first image in the save mode continuously from the viewing mode.

For example, the processing circuit 121 may save the first image to the recording medium 140 in the save mode. This makes it possible to save the displayed first image in the save mode. Thus, it is possible to save the displayed first image together with the second image in the save mode.

For example, the processing circuit 121 may display one or both of the second image and an analysis result of a subject based on the second image in the save mode. This makes it possible to display information corresponding to the second image in the save mode. Thus, it is possible to display the first image and information corresponding to the second image in the save mode.

For example, the processing circuit 121 may generate the first image based on the second image generated based on the compressed image in the save mode. The processing circuit 121 may display the first image on the display device 130.

This makes it possible to display the first image in both the viewing mode and the save mode. Thus, it is possible to display the first image in the save mode continuously from the viewing mode. Furthermore, it is possible to efficiently generate the first image based on the second image in the save mode. Thus, in the save mode, an increase in the processing load is suppressed.

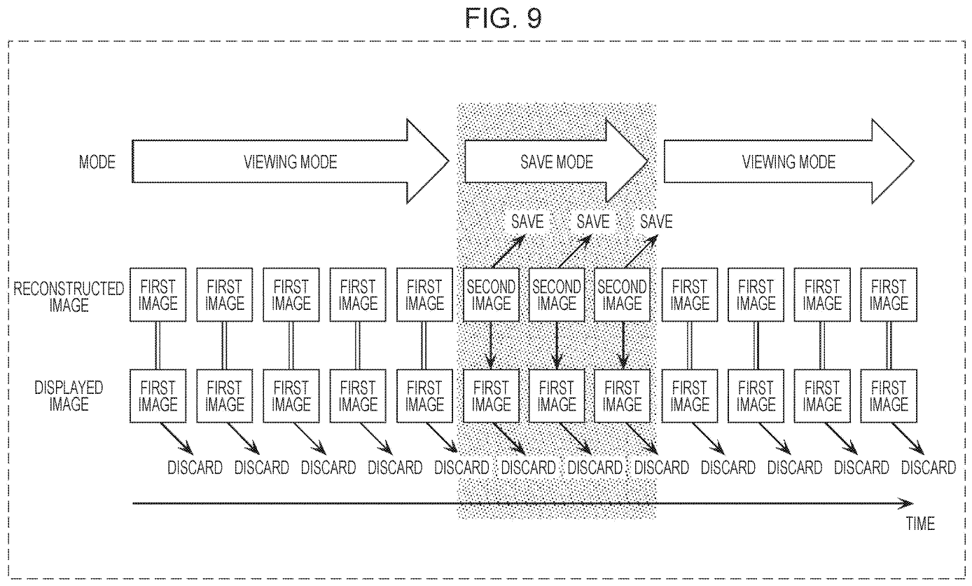

FIG. 9 is a conceptual diagram illustrating an operation example of the image processing system 100 illustrated in FIG. 1. For example, the image sensor 111 repeats imaging (photography) in accordance with a frame rate, thereby repeatedly acquiring a compressed image.

The processing circuit 121 selects a mode for each frame to switch between the viewing mode and the save mode. The viewing mode is also referred to as a display mode, a viewer mode, or an imaging (photography) mode, in which no image is saved. The save mode is also referred to as a recording mode, in which an image is saved.

In the viewing mode, the processing circuit 121 repeats operations of acquiring a compressed image via the image sensor 111, reconstructing a first image from the compressed image, displaying the first image on the display device 130, and discarding the first image. The first image may be an RGB image or a monochrome image. Alternatively, the first image may be the compressed image. In this case, the processing circuit 121 does not necessarily have to perform reconstruction processing in the viewing mode.

In the save mode, the processing circuit 121 repeats operations of acquiring a compressed image via the image sensor 111, reconstructing a second image from the compressed image, and saving the second image to the recording medium 140. The second image may be a hyperspectral image. Furthermore, in the save mode, the processing circuit 121 may repeat operations of generating a first image from a second image, displaying the first image on the display device 130, and discarding the first image.

Alternatively, in the save mode, the processing circuit 121 may reconstruct a first image from a compressed image as in the viewing mode. When the first image is a compressed image, the process of generating (reconstructing) the first image does not necessarily have to be performed. Alternatively, in the save mode, the processing circuit 121 may display the second image instead of the first image.

In the save mode, the processing circuit 121 may save the first image displayed on the display device 130 to the recording medium 140 in addition to the second image. That is, the processing circuit 121 may save the first image to the recording medium 140 without discarding the first image.

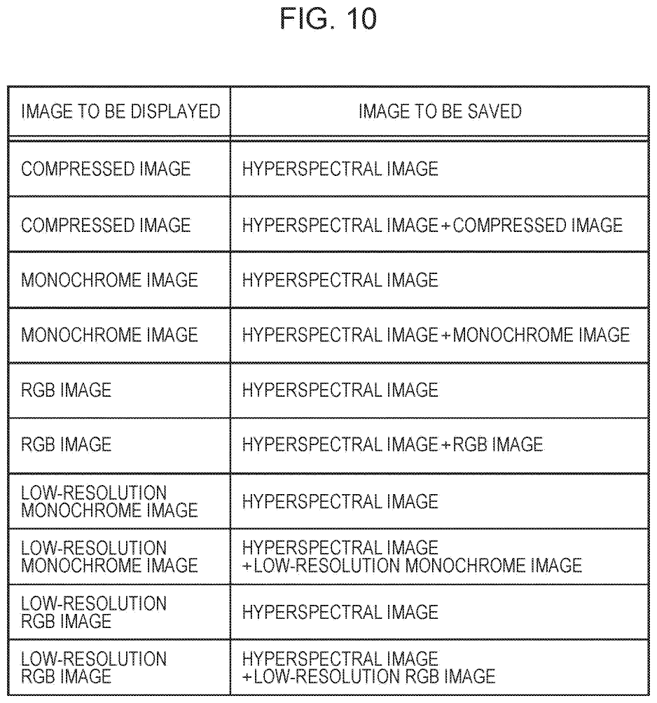

FIG. 10 is an explanatory diagram illustrating an example of combinations of the type of image to be displayed and the type of image to be saved in the operation example illustrated in FIG. 9.

Specifically, the image to be displayed is a first image. The image to be saved may be a second image or both a first image and a second image. The first image is, for example, a compressed image, a monochrome image, an RGB image, a low-resolution monochrome image, or a low-resolution RGB image. The second image is, for example, a hyperspectral image.

When the image to be displayed is a monochrome image, an RGB image, a low-resolution monochrome image, or a low-resolution RGB image, the image to be saved may include a compressed image. That is, in this case, the image to be saved may be two images, a hyperspectral image and a compressed image, or may be three images, a hyperspectral image, an image to be displayed, and a compressed image.

In any of these examples, when a hyperspectral image is not saved, that is, when the mode is not the save mode, no image is saved.

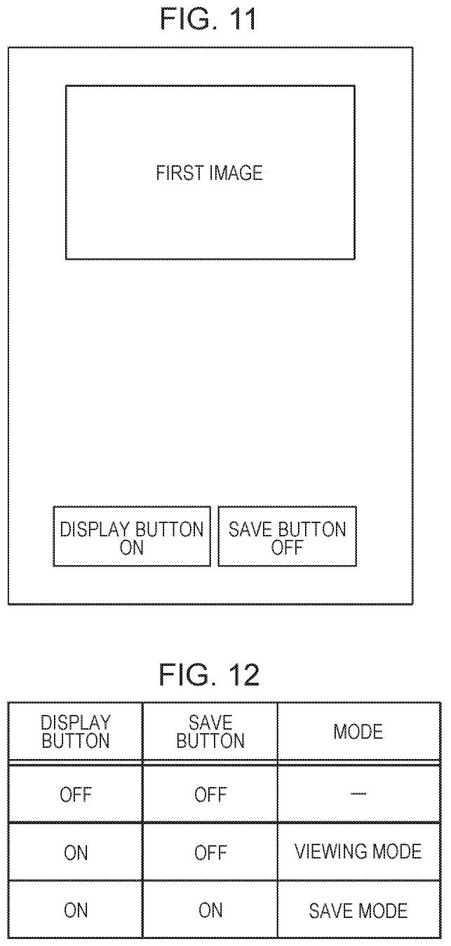

FIG. 11 is a conceptual diagram illustrating a first display example of the display device 130 illustrated in FIG. 1. For example, the display device 130 displays the GUI illustrated in FIG. 11. The GUI includes a first image, a display button, and a save button. The first image included in the GUI is a first image generated (reconstructed) by the processing circuit 121. The display button and the save button are each switched between ON and OFF by a user operation.

Switching between ON and OFF of the display button and the save button enables switching between the viewing mode and the save mode. The display button may be a photography button or a viewing button. The save button may be a recording button.

FIG. 12 is an explanatory diagram illustrating the relationship among the display button, the save button, and the mode according to the embodiment. When the display button is OFF, the save button is also OFF, and the mode has not been selected. In this case, any image is not generated and any image is not displayed.

When the display button is ON, the save button can be switched to ON or OFF. When the display button is ON and the save button is OFF, the mode is the viewing mode. When the display button is ON and the save button is ON, the mode is the save mode.

For example, when the display button is ON, a first image is displayed, and when the save button is ON, a second image is saved.

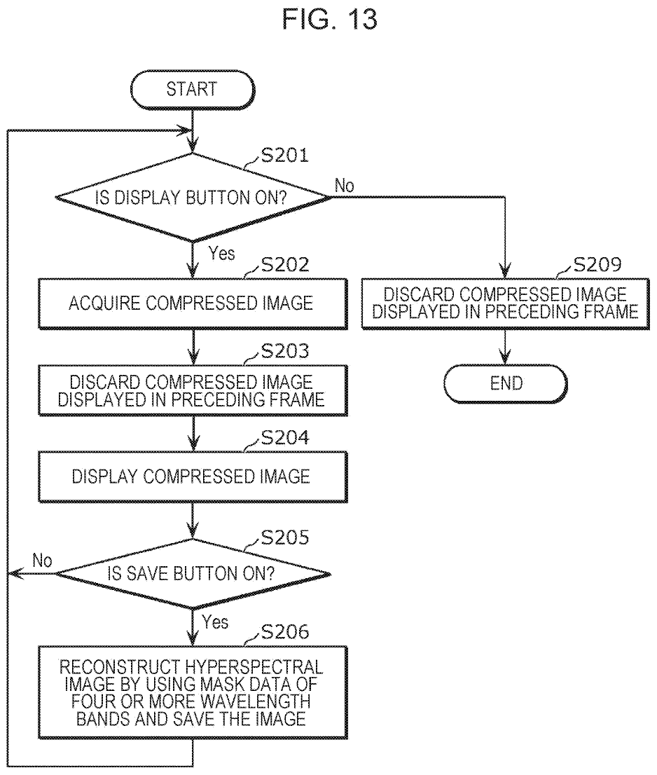

FIG. 13 is a flowchart illustrating a first specific example of the operation of the image processing system 100 illustrated in FIG. 1.

In this example, the processing circuit 121 determines whether the display button is ON (S201).

When the display button is ON (Yes in S201), the processing circuit 121 acquires a compressed image (S202). Specifically, the image sensor 111 generates a compressed image to acquire the compressed image, and the processing circuit 121 acquires the compressed image from the image sensor 111. Subsequently, the processing circuit 121 discards the compressed image displayed in the preceding frame (S203). Subsequently, the processing circuit 121 displays the compressed image acquired in the current frame (S204).

Furthermore, the processing circuit 121 determines whether the save button is ON (S205). When the save button is ON (Yes in S205), the processing circuit 121 reconstructs a hyperspectral image by using mask data of four or more wavelength bands, and saves the hyperspectral image (S206). Subsequently, the series of steps (S201 to S206) is repeated. On the other hand, when the save button is OFF (No in S205), the process (S201 to S205) is repeated without a hyperspectral image being reconstructed.

When the display button is OFF (No in S201), the processing circuit 121 discards the compressed image displayed in the preceding frame (S209). Subsequently, the image processing system 100 ends the operation.

In the example in FIG. 13, a hyperspectral image is reconstructed and saved when the save button is ON. When the display button is ON and the save button is OFF, a compressed image is displayed and a hyperspectral image is not reconstructed. Thus, the processing load is reduced.

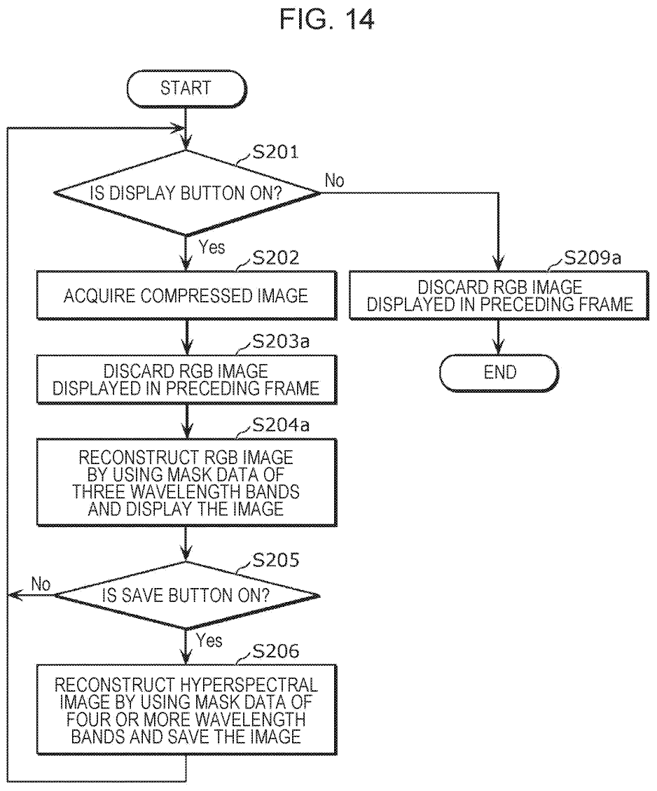

FIG. 14 is a flowchart illustrating a second specific example of the operation of the image processing system 100 illustrated in FIG. 1.

In the example in FIG. 14, compared to the example in FIG. 13, the processing circuit 121 reconstructs the RGB image of the current frame from the compressed image of the current frame by using mask data of three wavelength bands corresponding to the RGB image and displays the RGB image (S204a), instead of displaying the compressed image (S204).

In accordance with the reconstruction and display of the RGB image (S204a), the processing circuit 121 discards the RGB image displayed in the preceding frame (S203a and S209a), instead of discarding the compressed image displayed in the preceding frame (S203 and S209). At that time, the processing circuit 121 may discard the compressed image used in the preceding frame.

Except for the above, the example in FIG. 14 is the same as the example in FIG. 13. In the example in FIG. 14, a hyperspectral image is reconstructed and saved when the save button is ON. When the display button is ON and the save button is OFF, an RGB image is reconstructed and displayed, and a hyperspectral image is not reconstructed. Thus, the processing load is reduced.

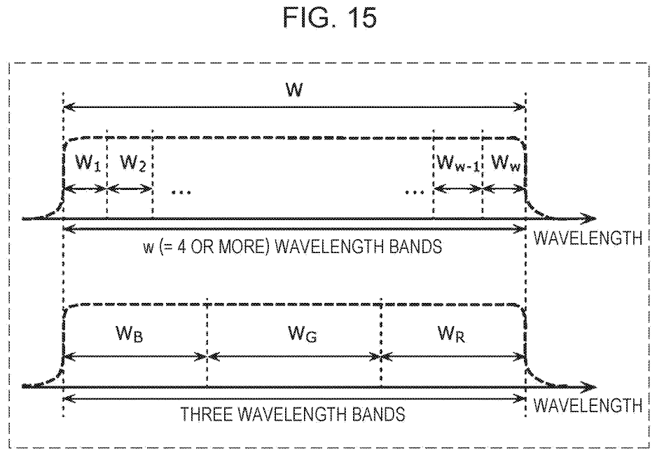

The reconstruction of an RGB image is performed in a similar manner to the reconstruction of a hyperspectral image by using mask data of three wavelength bands corresponding to the RGB image instead of mask data of four or more wavelength bands. For example, the reconstruction computation described in Patent Document 2 may be used. Specifically, a description will be given with reference to FIG. 15.

FIG. 15 is a conceptual diagram illustrating the relationship between four or more wavelength bands and three wavelength bands. In FIG. 15, W represents a wavelength range detectable by the image sensor 111. The wavelength range W may be the transmission wavelength range of a bandpass filter included in the image sensor 111.

The wavelength range W corresponds to the range covered by w (w is 4 or more) wavelength bands W₁, . . . , and W_{w} of a hyperspectral image. The wavelength range W corresponds to the range covered by three wavelength bands W_{R}, W_{G}, and W_{B} of an RGB image. That is, the range covered by the wavelength bands W₁, . . . , and W_{w} corresponds to the range covered by the three wavelength bands W_{R}, W_{G}, and W_{B} of an RGB image.

For example, the wavelength range W is in the range from 400 nm to 700 nm. For example, the w wavelength bands W₁, . . . , and W_{w} are determined in 10 nm steps. Thus, w is 30, and the w wavelength bands W₁, W₂, . . . , and W_{w} are 400 nm to 410 nm, 410 nm to 420 nm, . . . , and 690 nm to 700 nm, respectively. To generate a hyperspectral image of these w wavelength bands W₁, . . . , and W_{w}, mask data of the w wavelength bands W₁, . . . , and W_{w} is prepared.

The mask data of the w wavelength bands W₁, W₂, . . . , and W_{w} includes a transmittance matrix of the wavelength band of 400 nm to 410 nm, a transmittance matrix of the wavelength band of 410 nm to 420 nm, . . . , and a transmittance matrix of the wavelength band of 690 nm to 700 nm.

As a result of integrating ten matrices included in the range of the wavelength band W_{B} of 400 nm to 500 nm, a transmittance matrix of the wavelength band W_{B} is obtained. As a result of integrating ten matrices included in the range of the wavelength band W_{G} of 500 nm to 600 nm, a transmittance matrix of the wavelength band W_{G} is obtained. As a result of integrating ten matrices included in the range of the wavelength band W_{R} of 600 nm to 700 nm, a transmittance matrix of the wavelength band W_{R} is obtained.

In the integration of ten transmittance matrices, ten transmittances may be added together or ten transmittances may be averaged for each element. Accordingly, the mask data of the three wavelength bands W_{R}, W_{G}, and W_{B} corresponding to an RGB image is obtained from the mask data of the w wavelength bands W₁, . . . , and W_{w}. That is, the mask data of the three wavelength bands W_{R}, W_{G}, and W_{B} of an RGB image can be prepared from the mask data of the w wavelength bands W₁, . . . , and W_{w} in order to generate the RGB image.

When H included in expression (1) is expressed by H=(H₁ H₂ . . . . H_{w})=(H₁ H₂ . . . H_{P} H_{P+1} H_{P+2} . . . H_{Q} H_{Q+1} H_{Q+2} . . . H_{w}), a matrix HR indicating the mask data for the wavelength band W_{R}, a matrix HG indicating the mask data for the wavelength band W_{G}, and a matrix HB indicating the mask data for the wavelength band W_{B} may be expressed by expression (4) or expression (5). Each of H₁, H₂, . . . , H_{P}, H_{P+1}, H_{P+2}, . . . , HQ, H_{Q+1}, H_{Q+2}, . . . , and H_{w} is a submatrix of H and has components arranged in n×m rows and n×m columns.

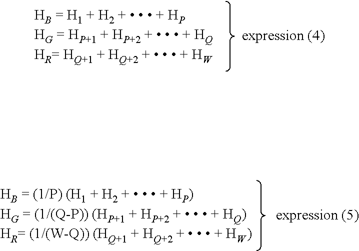

In the above example, P=10, Q=20, and W=30.

The processing circuit 121 is capable of generating an RGB image, based on the mask data of the three wavelength bands W_{R}, W_{G}, and W_{B} and the foregoing expressions (1) and (2). H and f included in expression (1) and expression (2) may be expressed as follows.

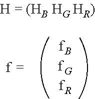

H_{B}, H_{G}, and H_{R} are each a submatrix of H.

f_{R} represents the data of a spectral image corresponding to the wavelength band W_{R}, that is, the pixel values of the image corresponding to the wavelength band W_{R}.

f_{G} represents the data of a spectral image corresponding to the wavelength band W_{G}, that is, the pixel values of the image corresponding to the wavelength band W_{G}.

f_{B} represents the data of a spectral image corresponding to the wavelength band W_{B}, that is, the pixel values of the image corresponding to the wavelength band W_{B}.

The pixel values included in the RGB image may be determined based on the n×m pixel values included in each of f_{R}, f_{G}, and f_{B}.

The mask data of the w wavelength bands W₁, . . . , and W_{w} has n×m×w (w is 4 or more) transmittance values reflecting n×m transmission spectra S₁₁, . . . , and Sₙₘ for n×m pixels. Similarly, the mask data of the three wavelength bands W_{R}, W_{B}, and W_{G} has n×m×3 transmittance values reflecting n×m transmission spectra S₁₁, . . . , and Sₙₘ for n×m pixels.

That is, it is possible to efficiently generate both the mask data for generating an RGB image and the mask data for generating a hyperspectral image from common transmission spectra. Thus, it is possible to reduce the number of calibrations.

In the above description, the mask data of the w wavelength bands W₁, . . . , and W_{w} of the hyperspectral image is used to derive the mask data of the three wavelength bands W_{R}, W_{B}, and W_{G} of the RGB image. However, the three transmittances of the three wavelength bands W_{R}, W_{B}, and W_{G} may be derived from the transmission spectra for each pixel, and thereby the mask data of the three wavelength bands W_{R}, W_{G}, and W_{B} may be derived, based on the foregoing expression (3).

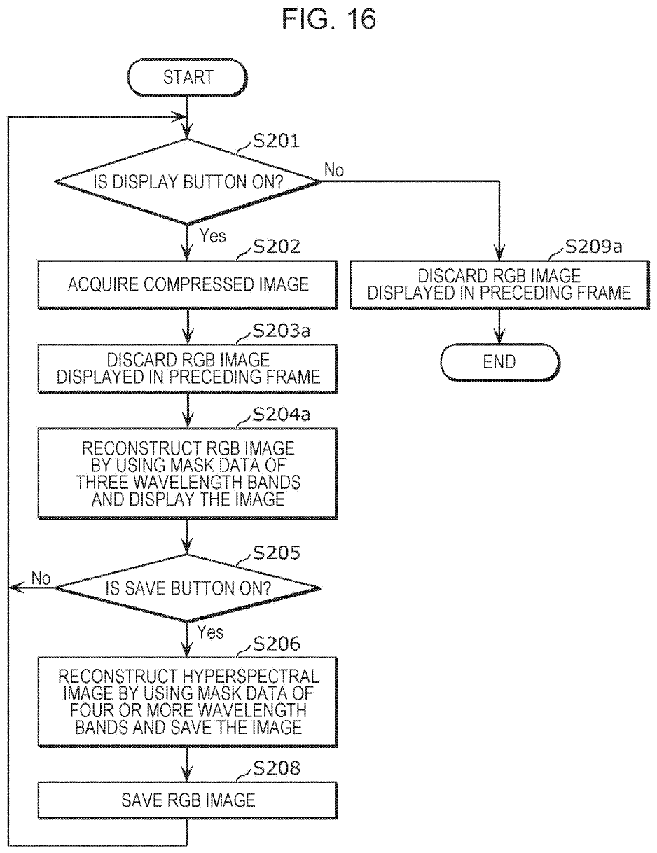

FIG. 16 is a flowchart illustrating a third specific example of the operation of the image processing system 100 illustrated in FIG. 1.

In the example in FIG. 16, compared to the example in FIG. 14, when the save button is ON (Yes in S205), the processing circuit 121 saves an RGB image in addition to a hyperspectral image (S208).

Except for the above, the example in FIG. 16 is the same as the example in FIG. 14. In the example in FIG. 16, a hyperspectral image is reconstructed and saved when the save button is ON. When the display button is ON and the save button is OFF, an RGB image is reconstructed and displayed, and a hyperspectral image is not reconstructed. Thus, the processing load is reduced.

In the example in FIG. 16, when the save button is ON, the displayed RGB image is saved. Thus, in the save mode, it is possible to save the RGB image that is effective for display, together with the hyperspectral image.

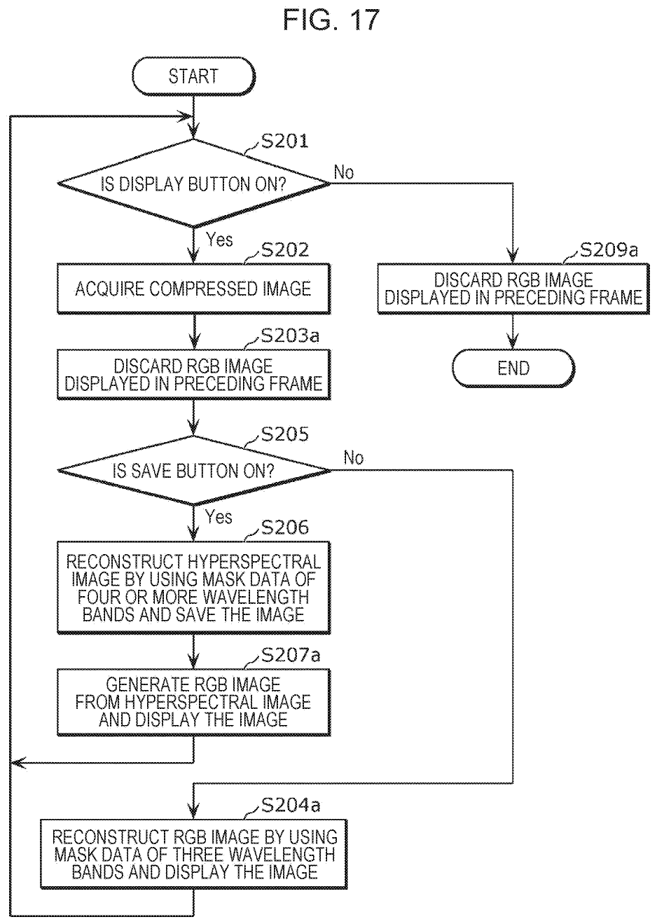

FIG. 17 is a flowchart illustrating a fourth specific example of the operation of the image processing system 100 illustrated in FIG. 1. In the example in FIG. 17, the method of generating an RGB image is different from that in the example in FIG. 14.

Specifically, in the example in FIG. 17, the method of generating an RGB image varies depending on whether the save button is ON. Specifically, when the save button is OFF (No in S205), an RGB image is reconstructed by using the mask data of three wavelength bands and is displayed (S204a). This process (S204a in FIG. 17) is the same as the process that is performed regardless of whether the save button is ON in the example in FIG. 14 (S204a in FIG. 14).

On the other hand, when the save button is ON (Yes in S205), the processing circuit 121 reconstructs a hyperspectral image, and then generates an RGB image from the hyperspectral image and displays the RGB image (S207a). Specifically, among the spectral images included in the hyperspectral image, spectral images of wavelength bands included in the red wavelength band W_{R} are integrated, and thereby a spectral image of the red wavelength band W_{R} is obtained. In the integration of the spectral images, the values of the spectral images may be added together, weighted added, or averaged, on a pixel-by-pixel basis.

Similarly, among the spectral images included in the hyperspectral image, spectral images of wavelength bands included in the green wavelength band W_{G} are integrated, and thereby a spectral image of the green wavelength band W_{G} is obtained. Furthermore, among the spectral images included in the hyperspectral image, spectral images of wavelength bands included in the blue wavelength band W_{B} are integrated, and thereby a spectral image of the blue wavelength band W_{B} is obtained.

Subsequently, the spectral image of the red wavelength band W_{R}, the spectral image of the green wavelength band W_{G}, and the spectral image of the blue wavelength band W_{B} are combined to obtain an RGB image.

Except for the above, the example in FIG. 17 is the same as the example in FIG. 14. In the example in FIG. 17, a hyperspectral image is reconstructed and saved when the save button is ON. When the display button is ON and the save button is OFF, an RGB image is reconstructed and displayed, and a hyperspectral image is not reconstructed. Thus, the processing load is reduced.

In the example in FIG. 17, when the save button is ON, an RGB image is generated from the reconstructed hyperspectral image. The processing load of such a generation process is smaller than the processing load of a reconstruction process of reconstructing an RGB image from a compressed image. Thus, the above operation reduces the processing load.

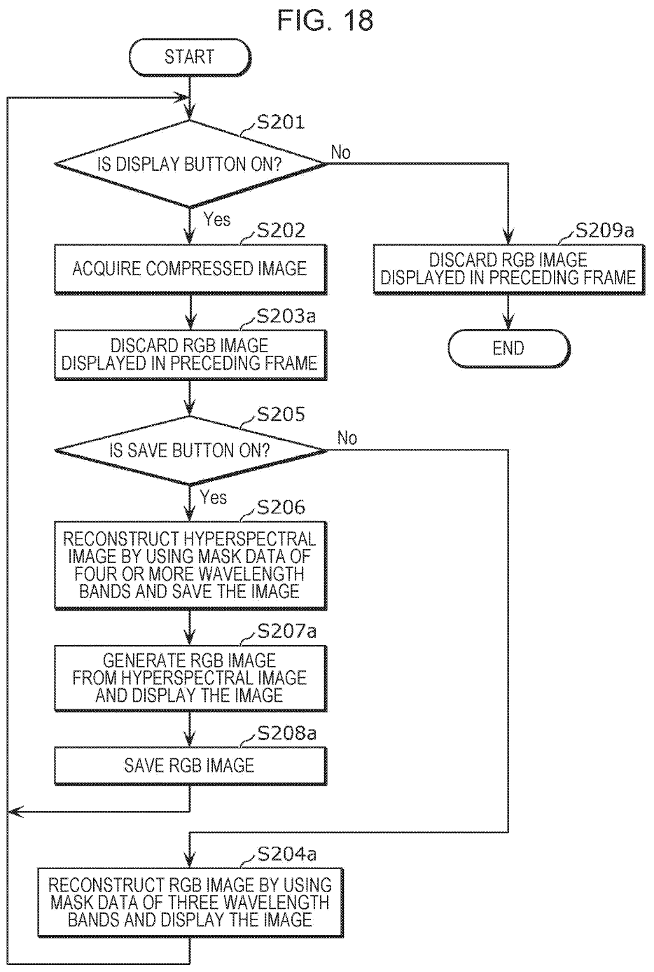

FIG. 18 is a flowchart illustrating a fifth specific example of the operation of the image processing system 100 illustrated in FIG. 1.

In the example in FIG. 18, compared to the example in FIG. 17, when the save button is ON (Yes in S205), the processing circuit 121 saves, in addition to a hyperspectral image, an RGB image generated from the hyperspectral image (S208a).

Except for the above, the example in FIG. 18 is the same as the example in FIG. 17. In the example in FIG. 18, a hyperspectral image is reconstructed and saved when the save button is ON. When the display button is ON and the save button is OFF, an RGB image is reconstructed and displayed, and a hyperspectral image is not reconstructed. Thus, the processing load is reduced.

In the example in FIG. 18, when the save button is ON, the displayed RGB image is saved. Thus, in the save mode, it is possible to save the RGB image that is effective for display, together with the hyperspectral image.

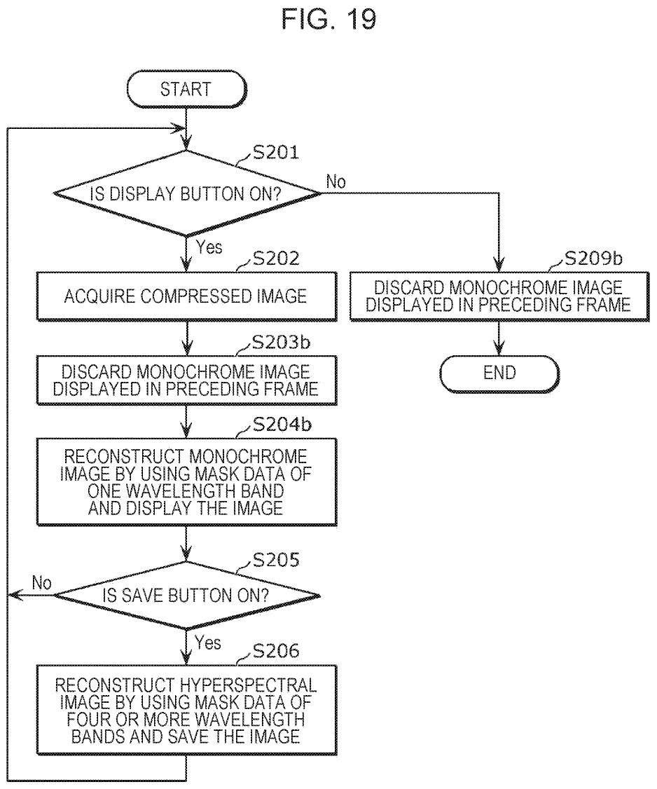

FIG. 19 is a flowchart illustrating a sixth specific example of the operation of the image processing system 100 illustrated in FIG. 1.

In the example in FIG. 19, compared to the example in FIG. 14, the processing circuit 121 reconstructs and displays a monochrome image (S204b), instead of reconstructing and displaying an RGB image (S204a). Specifically, at that time, the processing circuit 121 reconstructs a monochrome image of the current frame from a compressed image of the current frame by using the mask data of one wavelength band corresponding to the monochrome image, and displays the monochrome image.

In accordance with the reconstruction and display of the monochrome image (S204b), the processing circuit 121 discards the monochrome image displayed in the preceding frame (S203b and S209b), instead of discarding the RGB image displayed in the preceding frame (S203a and S209a). At that time, the processing circuit 121 may discard the compressed image used in the preceding frame.

Except for the above, the example in FIG. 19 is the same as the example in FIG. 14. In the example in FIG. 19, a hyperspectral image is reconstructed and saved when the save button is ON. When the display button is ON and the save button is OFF, a monochrome image is reconstructed and displayed, and a hyperspectral image is not reconstructed. Thus, the processing load is reduced.

The reconstruction of a monochrome image is performed in a similar manner to the reconstruction of a hyperspectral image by using mask data of one wavelength band corresponding to the monochrome image instead of mask data of four or more wavelength bands. Specifically, mask data of four or more wavelength bands may be integrated as in the reconstruction of an RGB image.

In the reconstruction of an RGB image, mask data of four or more wavelength bands is integrated into mask data of three wavelength bands with fewer elements. In the reconstruction of a monochrome image, mask data of four or more wavelength bands is integrated into mask data of one wavelength band with fewer elements.

Alternatively, one transmittance of one wavelength band may be derived from the transmission spectrum on a pixel-by-pixel basis in accordance with the foregoing expression (3), and thereby the mask data of one wavelength band may be derived. The one wavelength band may correspond to the wavelength range W detectable by the image sensor 111.

As a result of using a monochrome image, the amount of computation is reduced and the processing load is reduced compared to the case of using an RGB image.

When the save button is ON (Yes in S205), the processing circuit 121 may save, in addition to the hyperspectral image, the displayed monochrome image to the recording medium 140. This makes it possible to save the monochrome image that is effective for display, together with the hyperspectral image, in the save mode.

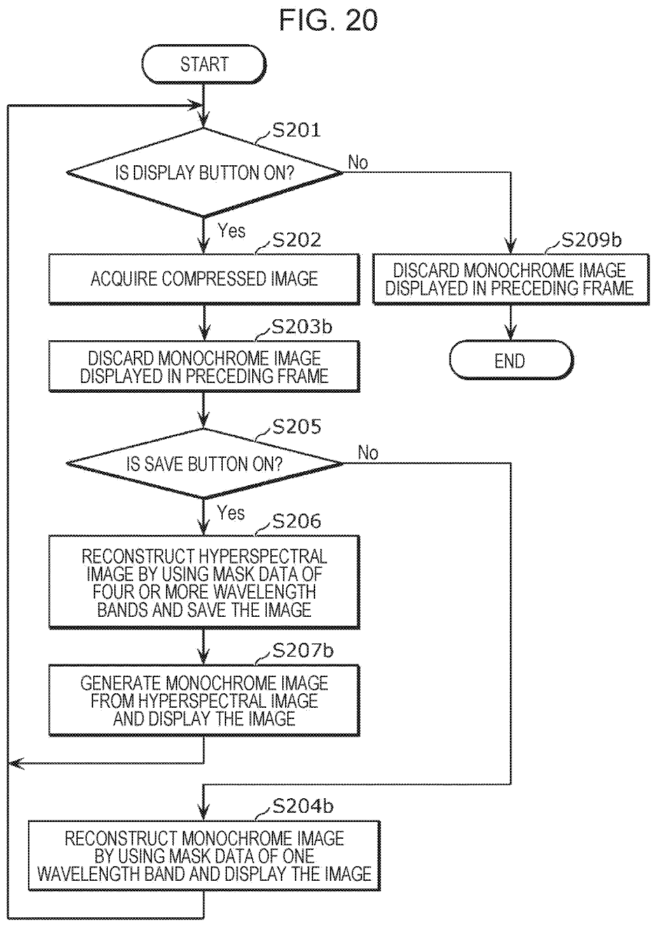

FIG. 20 is a flowchart illustrating a seventh specific example of the operation of the image processing system 100 illustrated in FIG. 1. In the example in FIG. 20, the method of generating a monochrome image is different from that in the example in FIG. 19.

Specifically, in the example in FIG. 20, the method of generating a monochrome image varies depending on whether the save button is ON. Specifically, when the save button is OFF (No in S205), a monochrome image is reconstructed by using the mask data of one wavelength band and is displayed (S204b). This process (S204b in FIG. 20) is the same as the process that is performed regardless of whether the save button is ON in the example in FIG. 19 (S204b in FIG. 19).

On the other hand, when the save button is ON (Yes in S205), the processing circuit 121 reconstructs a hyperspectral image, and then generates a monochrome image from the hyperspectral image and displays the monochrome image (S207b). Specifically, the spectral images included in the hyperspectral image are integrated, and thereby a monochrome image is obtained. In the integration of the spectral images, the values of the spectral images may be added together or averaged, on a pixel-by-pixel basis.

Except for the above, the example in FIG. 20 is the same as the example in FIG. 19. In the example in FIG. 20, a hyperspectral image is reconstructed and saved when the save button is ON. When the display button is ON and the save button is OFF, a monochrome image is reconstructed and displayed, and a hyperspectral image is not reconstructed. Thus, the processing load is reduced.

In the example in FIG. 20, when the save button is ON, a monochrome image is generated from the reconstructed hyperspectral image. The processing load of such a generation process is smaller than the processing load of a reconstruction process of reconstructing a monochrome image from a compressed image. Thus, the above operation reduces the processing load.

When the save button is ON (Yes in S205), the processing circuit 121 may save, in addition to the hyperspectral image, the displayed monochrome image to the recording medium 140. This makes it possible to save the monochrome image that is effective for display, together with the hyperspectral image, in the save mode.

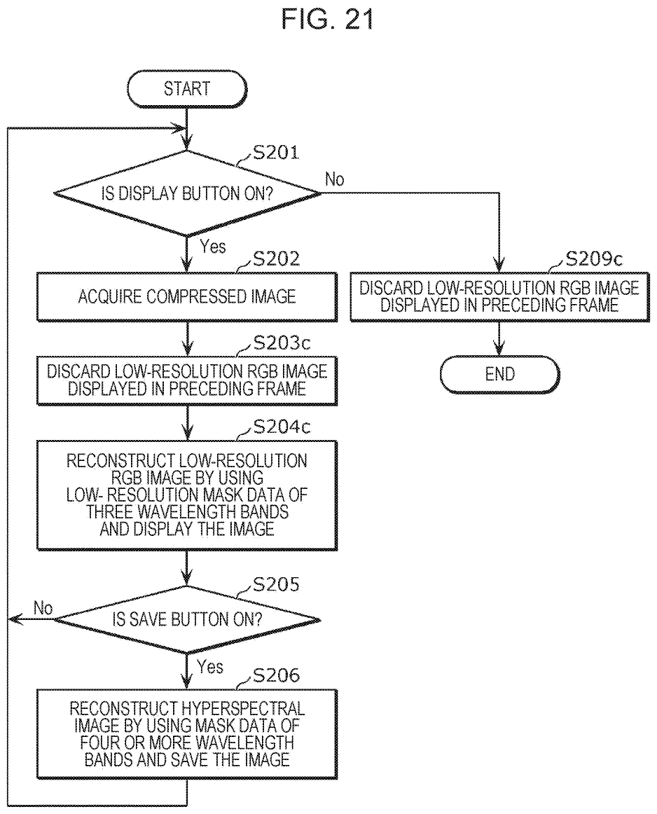

FIG. 21 is a flowchart illustrating an eighth specific example of the operation of the image processing system 100 illustrated in FIG. 1.

In the example in FIG. 21, compared to the example in FIG. 14, the processing circuit 121 reconstructs and displays a low-resolution RGB image (S204c), instead of reconstructing and displaying an RGB image (S204a). Specifically, at that time, the processing circuit 121 reconstructs a low-resolution RGB image of the current frame from a compressed image of the current frame by using low-resolution mask data of three wavelength bands corresponding to the RGB image, and displays the low-resolution RGB image.

In accordance with the reconstruction and display of the low-resolution RGB image (S204c), the processing circuit 121 discards the low-resolution RGB image displayed in the preceding frame (S203c and S209c), instead of discarding the RGB image displayed in the preceding frame (S203a and S209a). At that time, the processing circuit 121 may discard the compressed image used in the preceding frame.

Except for the above, the example in FIG. 21 is the same as the example in FIG. 14. In the example in FIG. 21, a hyperspectral image is reconstructed and saved when the save button is ON. When the display button is ON and the save button is OFF, a low-resolution RGB image is reconstructed and displayed, and a hyperspectral image is not reconstructed. Thus, the processing load is reduced. In addition, the amount of data of the low-resolution RGB image is smaller than that of the original RGB image. Thus, the processing load is reduced.

When the save button is ON (Yes in S205), the processing circuit 121 may save, in addition to the hyperspectral image, the displayed low-resolution RGB image to the recording medium 140. This makes it possible to save the low-resolution RGB image that is effective for display, together with the hyperspectral image, in the save mode.

There are three methods of reconstructing a low-resolution RGB image. The first method is a method of averaging both the mask data and the compressed image in the spatial direction and performing reconstruction computation of compressed sensing, thereby reconstructing a low-resolution RGB image.

Specifically, first, mask data of three wavelength bands corresponding to an RGB image is derived by using the method described with reference to FIG. 14 and FIG. 15. The mask data is averaged in the spatial direction, and thereby low-resolution mask data is obtained. Similarly, the compressed image is averaged in the spatial direction, and thereby a low-resolution compressed image is obtained. Subsequently, reconstruction computation of compressed sensing is performed by using the low-resolution mask data and the low-resolution compressed image, and thereby a low-resolution RGB image is derived.

Averaging in the spatial direction is performed by, for example, averaging four values into one value in units of 2×2-pixel blocks. Averaging may be performed in units of blocks other than 2×2-pixel blocks.

The second method is a method of subsampling both the mask data and the compressed image in the spatial direction and performing reconstruction computation of compressed sensing, thereby reconstructing a low-resolution RGB image. That is, thinning is performed instead of the averaging in the first method.

Subsampling in the spatial direction is performed by, for example, extracting one value at the upper left among four values in units of 2×2-pixel blocks. Subsampling may be performed in units of blocks other than 2×2-pixel blocks. In addition, the value at a position other than the upper left may be extracted.

The third method is a method of performing linear computation defined based on the assumption that pixels spatially adjacent to each other have the same pixel value spectrum, thereby reconstructing a low-resolution RGB image. The third method will be described in detail below.

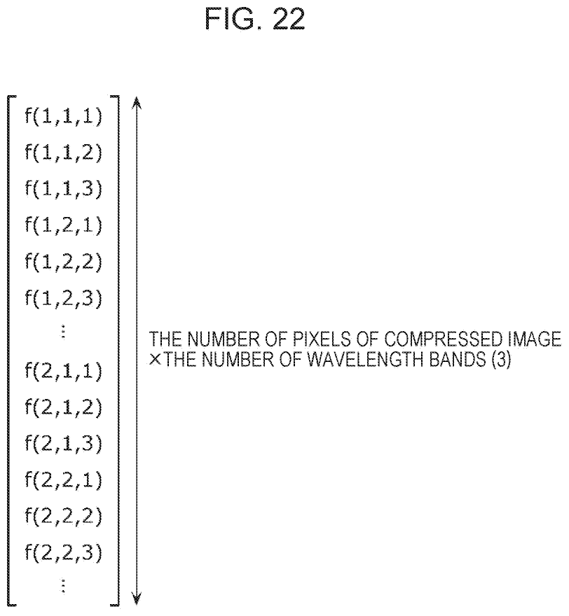

First, under the assumption that 2×2 pixels have the same pixel value spectrum, it is considered to reconstruct, as a reconstructed image, three low-resolution spectral images of three wavelength bands corresponding to a low-resolution RGB image. The relationship between the data g indicating the compressed image and the spectral images, that is, the data f indicating the reconstructed image, is expressed by g=Hf, as in expression (1). His the system matrix described above. To simplify the description, f is transformed into the form expressed in FIG. 22.

FIG. 22 is a diagram illustrating an example of the data f indicating a reconstructed image of three wavelength bands. In FIG. 22, f(a, b, c) indicates the pixel value of the c-th wavelength band at the pixel position (a, b).

That is, in expression (1), the order used is: the pixel value of the first wavelength band of the first pixel, the pixel value of the first wavelength band of the second pixel, . . . , the pixel value of the second wavelength band of the first pixel, the pixel value of the second wavelength band of the second pixel, . . . . In contrast, in the example in FIG. 22, the order used is: the pixel value of the first wavelength band of the first pixel, the pixel value of the second wavelength band of the first pixel, . . . , the pixel value of the first wavelength band of the second pixel, the pixel value of the second wavelength band of the second pixel, . . . .

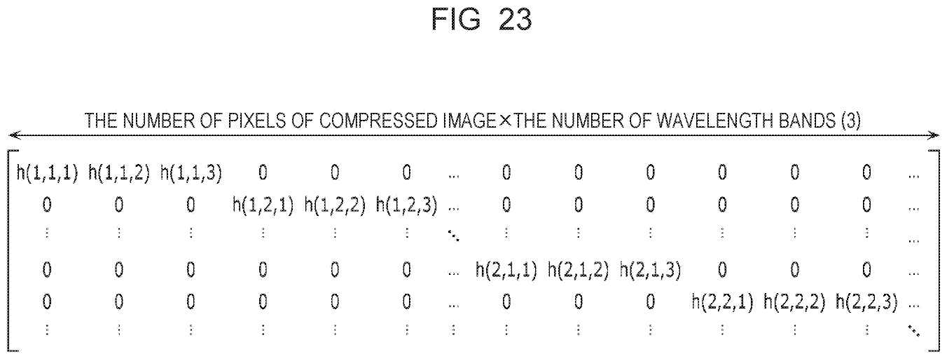

FIG. 23 is a diagram illustrating an example of the matrix H corresponding to mask data of three wavelength bands. The ordering of the columns of the matrix His transformed in accordance with the transformation of the data f. In FIG. 23, h(a, b, c) indicates the transmittance of the c-th wavelength band at the pixel position (a, b).

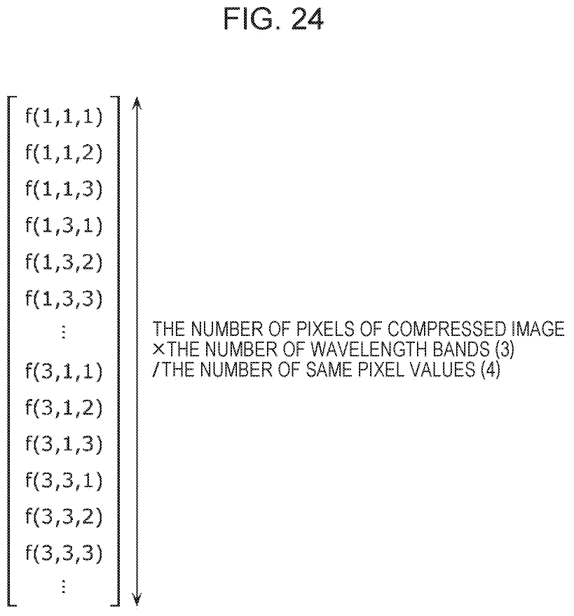

FIG. 24 is a diagram illustrating an example of the data f indicating a low-resolution reconstructed image of three wavelength bands. In the example in FIG. 24, for example, the pixel values f(1, 1, 1), f(1, 2, 1), f(2, 1, 1), and f(2, 2, 1) have the same value in accordance with the assumption, and thus these four pixel values can be aggregated into one pixel value f(1, 1, 1). The aggregation into one pixel value is performed in units of four pixel values in a similar manner, and accordingly the number of rows of the data f is reduced to ¼.

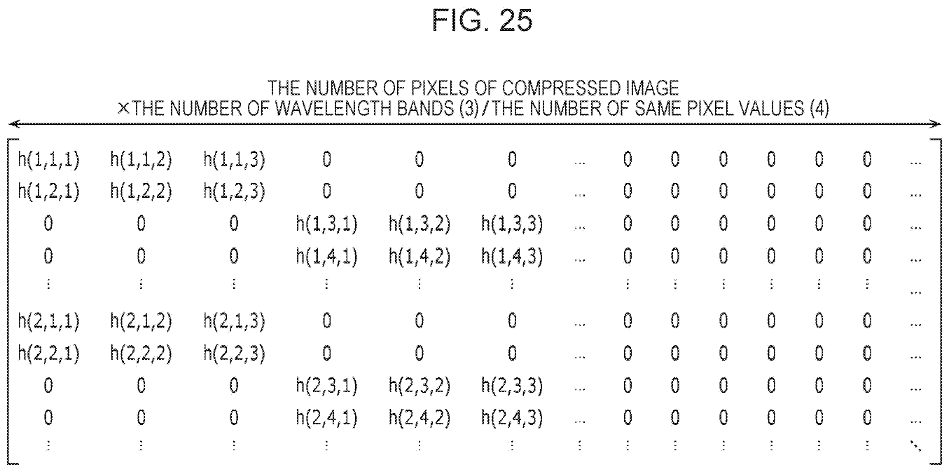

FIG. 25 is a diagram illustrating an example of the matrix H corresponding to low-resolution mask data of three wavelength bands. The number of columns in the matrix His reduced as the number of rows in the data f is reduced. The number of rows in the matrix H is maintained at the number of pixels of the compressed image. For example, the pixel value f(1, 1, 1) obtained through aggregation has an influence on the four pixel values included in the data g. The leftmost column in the matrix H represents the influence.

In accordance with the transformation described above, the number of rows in the data f becomes smaller than the number of rows in the data g. Thus, the number of unknown numbers reduces, and the data f can be derived by linear computation. For example, the data f can be derived by linear computation of f=H⁺g. Here, H⁺ represents the pseudo-inverse matrix of the matrix H.

In the above, the data f of three wavelength bands is derived based on the assumption that 2×2 pixels have the same pixel value spectrum. However, pixels having the same pixel value spectrum are not limited to 2×2 pixels, and the data f is not limited to data of three wavelength bands.

For example, in the case of deriving the data f of N wavelength bands based on the assumption that a×b pixels have the same pixel value spectrum, when a×b=N, the data f can be derived by linear computation of f=H⁻¹g. When a×b>N, the data f can be derived by linear computation of f=H⁺g.

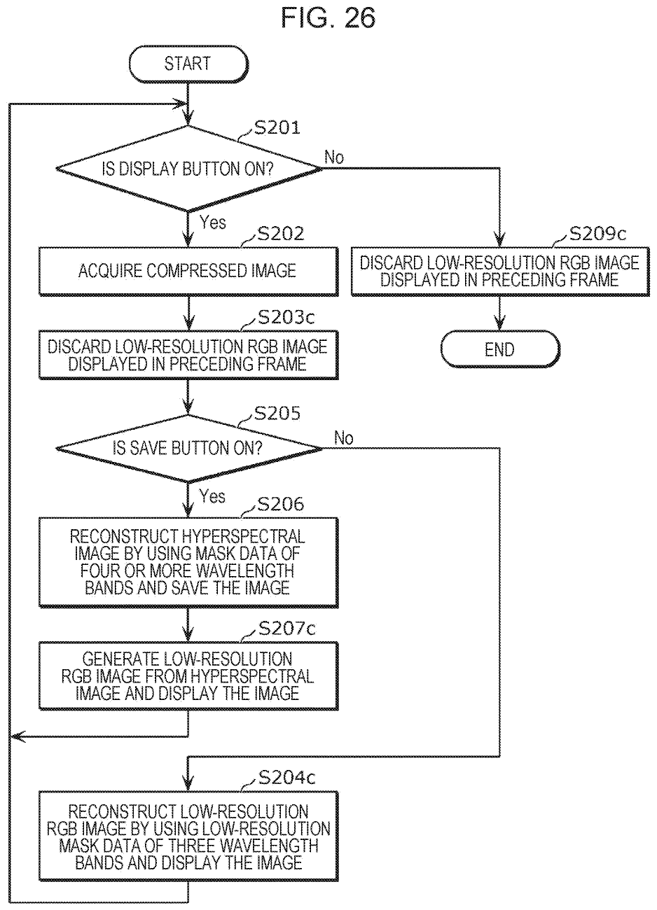

FIG. 26 is a flowchart illustrating a ninth specific example of the operation of the image processing system 100 illustrated in FIG. 1. In the example in FIG. 26, the method of generating a low-resolution RGB image is different from that in the example in FIG. 21.

Specifically, in the example in FIG. 26, the method of generating a low-resolution RGB image varies depending on whether the save button is ON. Specifically, when the save button is OFF (No in S205), a low-resolution RGB image is reconstructed by using the low-resolution mask data of three wavelength bands and is displayed (S204c). This process (S204c in FIG. 26) is the same as the process that is performed regardless of whether the save button is ON in the example in FIG. 21 (S204c in FIG. 21).

On the other hand, when the save button is ON (Yes in S205), the processing circuit 121 reconstructs a hyperspectral image, and then generates a low-resolution RGB image from the hyperspectral image and displays the low-resolution RGB image (S207c). Specifically, among the spectral images included in the hyperspectral image, spectral images of wavelength bands included in the red wavelength band W_{R} are integrated, and thereby a low-resolution spectral image of the red wavelength band W_{R} is obtained.

In the integration of the spectral images, the values of the spectral images may be added together or averaged, for example, in units of 2×2-pixel blocks. The integration may be performed in units of blocks other than 2×2-pixel blocks.

Similarly, among the spectral images included in the hyperspectral image, spectral images of wavelength bands included in the green wavelength band W_{G} are integrated, and thereby a low-resolution spectral image of the green wavelength band W_{G} is obtained. Also, among the spectral images included in the hyperspectral image, spectral images of wavelength bands included in the blue wavelength band W_{B} are integrated, and thereby a low-resolution spectral image of the blue wavelength band W_{B} is obtained.

Subsequently, the low-resolution spectral image of the red wavelength band W_{R}, the low-resolution spectral image of the green wavelength band W_{G}, and the low-resolution spectral image of the blue wavelength band W_{B} are combined to obtain a low-resolution RGB image.

Except for the above, the example in FIG. 26 is the same as the example in FIG. 21. In the example in FIG. 26, a hyperspectral image is reconstructed and saved when the save button is ON. When the display button is ON and the save button is OFF, a low-resolution RGB image is reconstructed and displayed, and a hyperspectral image is not reconstructed. Thus, the processing load is reduced.

In the example in FIG. 26, when the save button is ON, a low-resolution RGB image is generated from the reconstructed hyperspectral image.

When the save button is ON (Yes in S205), the processing circuit 121 may save, in addition to the hyperspectral image, the displayed low-resolution RGB image to the recording medium 140. This makes it possible to save the low-resolution RGB image that is effective for display, together with the hyperspectral image, in the save mode.

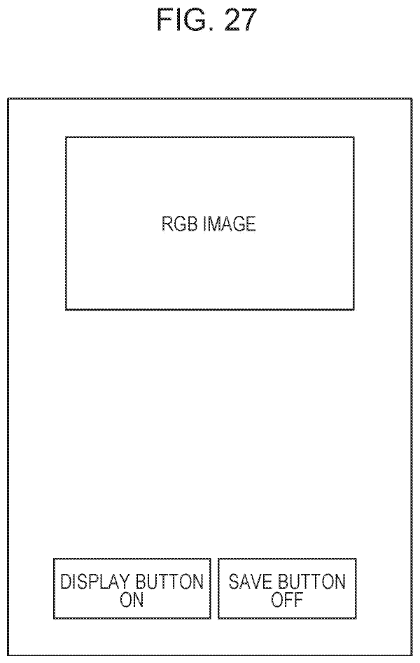

FIG. 27 is a conceptual diagram illustrating a second display example of the display device 130 illustrated in FIG. 1. For example, the processing circuit 121 displays an RGB image as a first image on the display device 130 in the viewing mode. In the viewing mode, the RGB image that is displayed is an RGB image reconstructed from a compressed image. In the viewing mode, a hyperspectral image is not reconstructed and is not displayed.

For example, the RGB image is updated in accordance with a frame rate. That is, the RGB image corresponds to a video. The RGB image is checked by a user, and the position, orientation, angle of view, and so forth of the imaging device 110 are adjusted so that the subject to be imaged is included in a hyperspectral image. After the adjustment, the mode is switched from the viewing mode to the save mode.

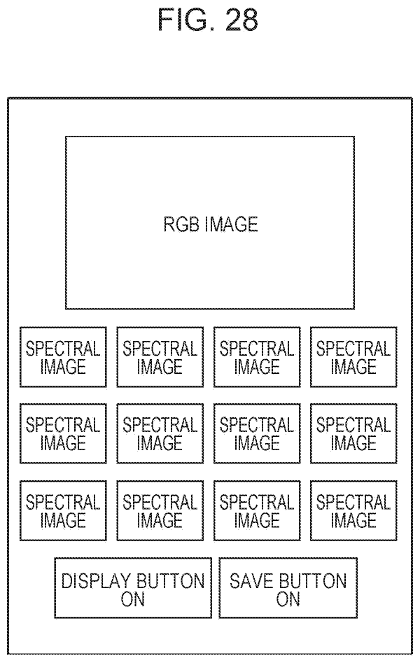

FIG. 28 is a conceptual diagram illustrating a third display example of the display device 130 illustrated in FIG. 1. For example, the processing circuit 121 displays an RGB image and a hyperspectral image respectively serving as a first image and a second image on the display device 130 in the save mode. The processing circuit 121 displays the hyperspectral image in the form of spectral images on the display device 130. In this example, the hyperspectral image includes twelve spectral images respectively corresponding to twelve wavelength bands.

In the save mode, the RGB image that is displayed may be an RGB image reconstructed from a compressed image or may be an RGB image generated from a hyperspectral image. For example, an RGB image generated by combining one or more spectral images corresponding to R, one or more spectral images corresponding to G, and one or more spectral images corresponding to B may be displayed.

After the mode has been switched from the save mode to the viewing mode, the display of the hyperspectral image last reconstructed in the save mode may be continued in the viewing mode.

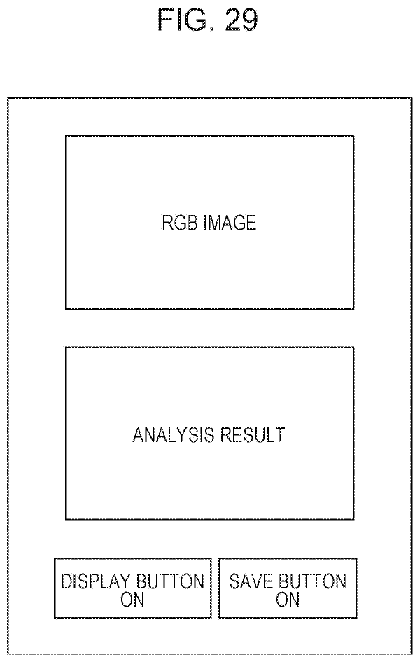

FIG. 29 is a conceptual diagram illustrating a fourth display example of the display device 130 illustrated in FIG. 1. For example, the processing circuit 121 displays an RGB image and an analysis result of a subject based on a hyperspectral image on the display device 130 in the save mode.

The analysis result of a subject based on a hyperspectral image may be an image showing a recognition result of the subject recognized based on the hyperspectral image. The analysis result may be an image obtained by processing the RGB image and the hyperspectral image. The analysis result may be statistical information about the hyperspectral image and may be displayed in the text format.

The processing circuit 121 may further display the hyperspectral image on the display device 130 in the save mode. That is, the processing circuit 121 may display the RGB image, the hyperspectral image, and the analysis result of the subject based on the hyperspectral image on the display device 130 in the save mode.

Alternatively, the processing circuit 121 may display the hyperspectral image on the display device 130 instead of the RGB image in the save mode. That is, the processing circuit 121 may display the hyperspectral image and the analysis result of the subject based on the hyperspectral image on the display device 130 in the save mode.

The processing circuit 121 may save, in addition to the hyperspectral image, the analysis result of the subject based on the hyperspectral image to the recording medium 140 in the save mode.

After the mode has been switched from the save mode to the viewing mode, the display of the analysis result obtained last in the save mode may be continued in the viewing mode.

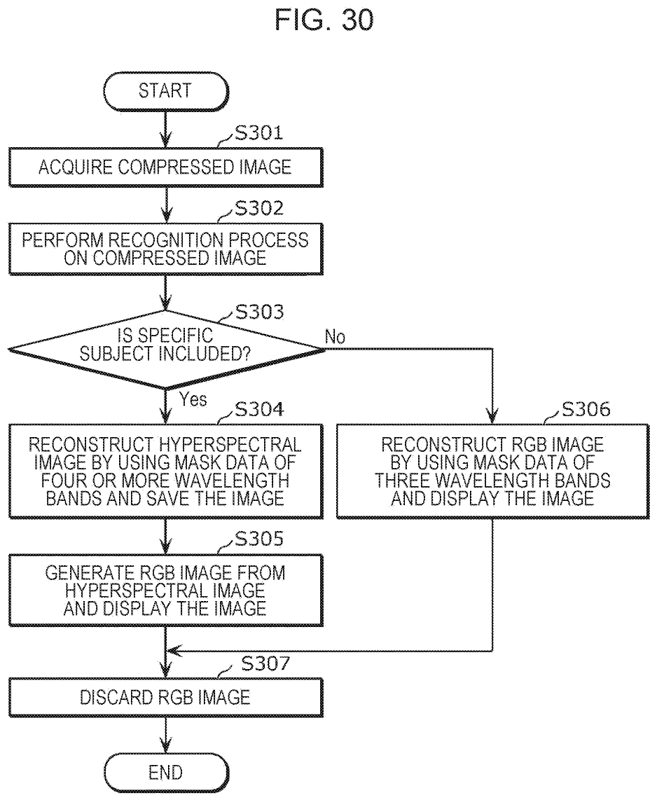

FIG. 30 is a flowchart illustrating a tenth specific example of the operation of the image processing system 100 illustrated in FIG. 1.

In this example, the processing circuit 121 acquires a compressed image (S301). Specifically, the image sensor 111 generates a compressed image to acquire the compressed image, and the processing circuit 121 acquires the compressed image from the image sensor 111.

Subsequently, the processing circuit 121 performs a recognition process on the compressed image (S302). The recognition process performed here may be the recognition process described in Patent Document 3.

Specifically, for example, the processing circuit 121 may apply preprocessing for increasing recognition accuracy to the compressed image. The preprocessing may include region extraction, smoothing, feature extraction, edge detection, or any combination thereof. Thereafter, the processing circuit 121 may perform a recognition process for a subject included in the pre-processed compressed image by using a learning model. The learning model may be a deep learning model such as a convolutional neural network (CNN) or a recurrent neural network (RNN).

The processing circuit 121 determines, based on a result of the recognition process, whether the compressed image includes a specific subject (S303). That is, the processing circuit 121 determines whether a specific subject is present in the compressed image.

When the compressed image includes a specific subject (Yes in S303), the processing circuit 121 reconstructs a hyperspectral image by using mask data of four or more wavelength bands, and saves the hyperspectral image to the recording medium 140 (S304). Subsequently, the processing circuit 121 generates an RGB image from the hyperspectral image and displays the RGB image on the display device 130 (S305).

When the compressed image does not include a specific subject (No in S303), the processing circuit 121 reconstructs an RGB image by using mask data of the three wavelength bands, and displays the RGB image on the display device 130 (S306).

Subsequently, the processing circuit 121 discards the displayed RGB image (S307). After that, the image processing system 100 ends the process. The image processing system 100 may repeatedly perform the series of operations (S301 to S307).

In the above-described operation, switching between the viewing mode and the save mode is performed in accordance with whether a subject is included in the compressed image. That is, when a subject is included in the compressed image, the save mode is used. When a subject is not included in the compressed image, the viewing mode is used. Thus, the processing load is reduced. In addition, the recognition process is performed on the compressed image without the hyperspectral image being reconstructed. Accordingly, the total throughput and processing time are reduced.

The image processing system 100 that performs the above-described recognition process may be applied to a foreign matter inspection in a factory. Specifically, the image processing system 100 may perform a foreign matter recognition process on a compressed image by using a learning model. When a foreign matter is present in the compressed image, the image processing system 100 may reconstruct a hyperspectral image from the compressed image and save the hyperspectral image. The image processing system 100 may present the hyperspectral image to a user or remove the foreign matter by using the hyperspectral image.

The image processing system 100 that performs the above-described recognition process may be applied to recognition of a facial skin condition. Specifically, the image processing system 100 may perform a face recognition process on a compressed image by using a learning model. When a face is present in the compressed image, the image processing system 100 may reconstruct a hyperspectral image from the compressed image and save the hyperspectral image. The image processing system 100 may perform recognition of a facial skin condition by using the hyperspectral image.

The image processing system 100 that performs the above-described recognition process may be applied to a recognition process in a belt conveyor. Specifically, the image processing system 100 may perform a recognition process for a two-dimensional barcode installed near an object, based on a compressed image. When a two-dimensional barcode is present in the compressed image, the image processing system 100 may reconstruct a hyperspectral image for processing the object from the compressed image.

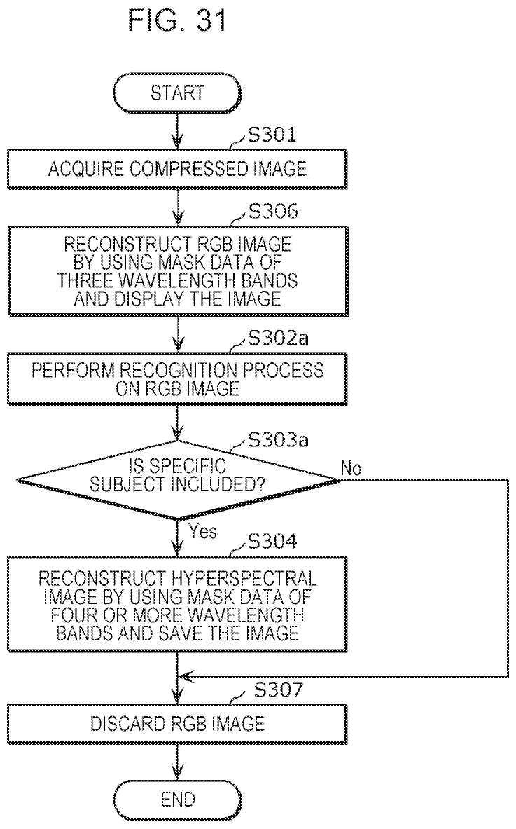

FIG. 31 is a flowchart illustrating an eleventh specific example of the operation of the image processing system 100 illustrated in FIG. 1.

In this example, the processing circuit 121 acquires a compressed image (S301). This process is the same as that in the example in FIG. 30.

Subsequently, the processing circuit 121 reconstructs an RGB image by using mask data of three wavelength bands and displays the RGB image on the display device 130 (S306). This process is the same as that performed in the example in FIG. 30 when a specific subject is not included in the compressed image.

Subsequently, the processing circuit 121 performs a recognition process on the RGB image (S302a). The processing circuit 121 determines, based on a result of the recognition process, whether a specific subject is included in the RGB image (S303a). In the example in FIG. 30, a compressed image is used, whereas in the example in FIG. 31, an RGB image is used. Except for the difference between the compressed image and the RGB image, the process is the same as that in the example in FIG. 30.

When the RGB image includes a specific subject (Yes in S303a), the processing circuit 121 reconstructs a hyperspectral image by using mask data of four or more wavelength bands and saves the hyperspectral image to the recording medium 140 (S304). This process is the same as that in the example in FIG. 30. When the RGB image does not include a specific subject (No in S303a), a hyperspectral image is not reconstructed and is not saved.

Subsequently, the processing circuit 121 discards the displayed RGB image (S307). After that, the image processing system 100 ends the process. The image processing system 100 may repeatedly perform the series of operations (S301 to S307). In the example in FIG. 31, an RGB image is used for a recognition process. Thus, color information can be used in the recognition process. Accordingly, a more complicated recognition process can be performed with high accuracy.

While the image processing system and so forth have been described in accordance with the embodiment, aspects of the image processing system and so forth are not limited to the embodiment. Modifications conceived by those skilled in the art may be applied to the embodiment, or components in the embodiment may be combined in any manner.

For example, a process performed by a specific component in the embodiment may be performed by another component instead of the specific component. The order of processes may be changed, or processes may be performed in parallel. The ordinal numbers used in the description, such as first and second, may be substituted, removed, or newly given as appropriate. These ordinal numbers do not necessarily correspond to a meaningful order and may be used to identify elements.

For example, the expression “at least one of a first element, a second element, or a third element” corresponds to the first element, the second element, the third element, or any combination thereof.

A method including steps performed by the individual components of the image processing system or the like may be executed by any system or device. That is, the method may be executed by the above-described image processing system or the like, or may be executed by another system or device.

For example, a part or the entirety of the method may be executed by a computer including a processor, a memory, an input/output circuit, and so forth. In this case, the computer may execute a program for causing the computer to execute the method, and thereby the method may be executed.

For example, the foregoing program causes the computer to execute an image processing method including: acquiring a compressed image; switching between a viewing mode and a save mode; in the viewing mode, displaying a first image on a display device and deleting the first image after displaying the first image, the first image being either the compressed image or a display-processed image that is generated based on the compressed image and represented by information of three or fewer wavelength bands; and in the save mode, generating, based on the compressed image, a second image represented by information of four or more wavelength bands, and saving the second image to a recording medium.

Furthermore, the foregoing program may be recorded on a non-transitory computer-readable recording medium such as a CD-ROM.

The individual components of the image processing system or the like may be constituted by dedicated hardware, may be constituted by general-purpose hardware that executes the foregoing program or the like, or may be constituted by a combination thereof. The general-purpose hardware may be constituted by a memory storing a program, and a general-purpose processor or the like that reads the program from the memory and executes the program. The memory herein may be a semiconductor memory, a hard disk, or the like, and the general-purpose processor may be a central processing unit (CPU) or the like.

The dedicated hardware may be constituted by a memory and a dedicated processor or the like. For example, the dedicated processor may execute the above-described method with reference to the memory.

The individual components of the image processing system or the like may be electrical circuits. These electrical circuits may constitute one electrical circuit as a whole, or may be separate electrical circuits. These electrical circuits may correspond to dedicated hardware or to general-purpose hardware that executes the foregoing program or the like.

### Others

Modifications of the embodiment of the present disclosure may be as follows.

### Modification A

A device including:
an image sensor including first pixels; and
a controller, in which
the image sensor receives first light from a filter array including four or more filters having transmission spectra different from each other in a wavelength range, and thereafter outputs first pixel values of the first pixels,
the image sensor receives second light from the filter array and thereafter outputs second pixel values of the first pixels,
the image sensor receives the first light and thereafter receives the second light,
the controller executes a first process before receiving an instruction,
the controller executes a second process after receiving the instruction,
in the first process, the controller generates third pixel values corresponding to a first wavelength band, fourth pixel values corresponding to a second wavelength band, and fifth pixel values corresponding to a third wavelength band, based on the first pixel values and first information,
a total number of the third pixel values is identical to a total number of the first pixel values,
a total number of the fourth pixel values is identical to the total number of the first pixel values,
a total number of the fifth pixel values is identical to the total number of the first pixel values,
in the first process, the controller generates a first image, based on the third pixel values, the fourth pixel values, and the fifth pixel values,
in the first process, the controller does not generate four or more second images corresponding one-to-one to four or more wavelength bands, based on the first pixel values and second information,
in the second process, the controller generates sixth pixel values corresponding to the first wavelength band, seventh pixel values corresponding to the second wavelength band, and eighth pixel values corresponding to the third wavelength band, based on the second pixel values and the first information,
a total number of the sixth pixel values is identical to the total number of the first pixel values,
a total number of the seventh pixel values is identical to the total number of the first pixel values,
a total number of the eighth pixel values is identical to the total number of the first pixel values,
in the second process, the controller generates a third image, based on the sixth pixel values, the seventh pixel values, and the eighth pixel values, in the second process, the controller generates four or more fourth images corresponding one-to-one to the four or more wavelength bands, based on the second pixel values and the second information,
the wavelength range includes the first wavelength band, the second wavelength band, and the third wavelength band,
the wavelength range includes the four or more wavelength bands,
the first wavelength band has a first width, the second wavelength band has a second width, and the third wavelength band has a third width, and
the four or more wavelength bands each have a bandwidth that is smaller than the first width, smaller than the second width, and smaller than the third width.

### Modification B

The device according to the foregoing modification A, further including a memory, in which the first information and the second information are stored in the memory before the image sensor receives the first light.

### Modification C

The device according to the foregoing modification A or B, in which the instruction indicates displaying four or more images corresponding one-to-one to the four or more wavelength bands on a display.

### Description of Modification A

The first pixel values may be the matrix g of n×m rows and one column expressed by expression (1). In this description, the first pixel values are referred to as a matrix g1 of n×m rows and one column.

The second pixel values may be the matrix g of n×m rows and one column expressed by expression (1). In this description, the second pixel values are referred to as a matrix g2 of n×m rows and one column.

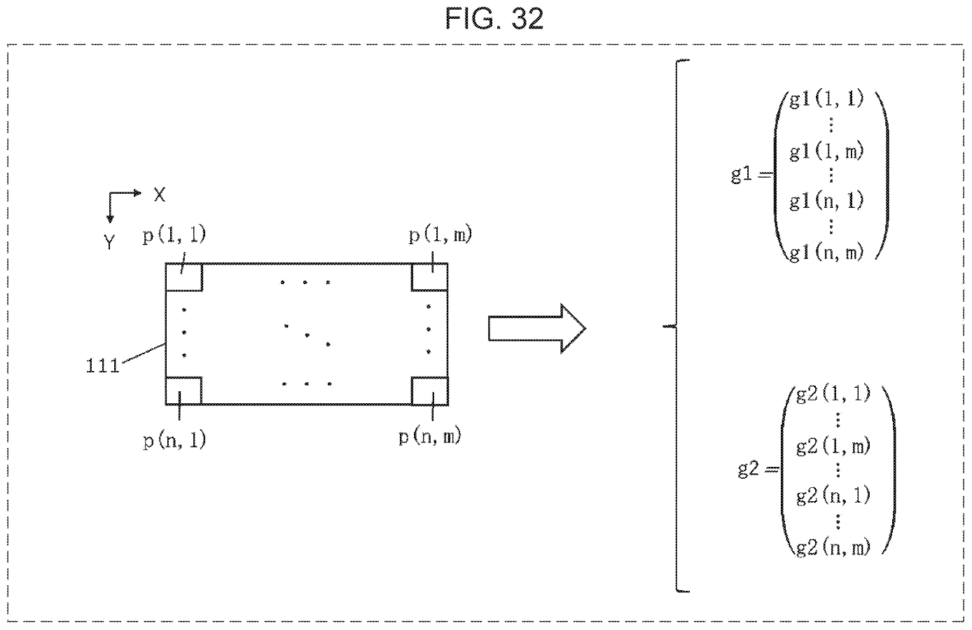

FIG. 32 is a diagram illustrating an example of the relationship between the first pixels included in the image sensor and the first pixel values, and the relationship between the first pixels included in the image sensor and the second pixel values.

The first pixels may be a pixel p(1, 1), . . . , and a pixel p(n, m).

The first pixel values may be a pixel value g1(1, 1) output by the pixel p(1, 1), . . . , and a pixel value g1(n, m) output by the pixel p(n, m).

The second pixel values may be a pixel value g2(1, 1) output by the pixel p(1, 1), . . . , and a pixel value g2(n, m) output by the pixel p(n, m).

The wavelength range may be the wavelength range W illustrated in FIG. 15.

The first information may be a matrix H₁=(H_{B} H_{G} H_{R}) of n×m rows and n×m×3 columns. H_{B}, H_{G}, and H_{R} are each a submatrix of H₁.

The third pixel values corresponding to the first wavelength band may be represented as n×m components included in a matrix f_{1R} of n×m rows and one column corresponding to the wavelength band W_{R}, the fourth pixel values corresponding to the second wavelength band may be represented as n×m components included in a matrix f_{1G} of n×m rows and one column corresponding to the wavelength band W_{G}, and the fifth pixel values corresponding to the third wavelength band may be represented as n×m components included in a matrix f_{1B} of n×m rows and one column corresponding to the wavelength band W_{B}.

Expression (1) can be expressed as follows.

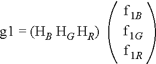

The first image may be a first RGB image generated based on f_{1R}, f_{1G}, and f_{1B}.

The second information may be a matrix H₂=(H₁ H₂ . . . . H_{w}) of n×m rows and n×m×w columns. H₁, H₂, . . . , and H_{w} are each a submatrix of H₂.

The four or more wavelength bands may be the wavelength band W₁, . . . , and the wavelength band W_{w} illustrated in FIG. 15.

In modification A, “in the first process, the controller does not generate four or more second images corresponding one-to-one to four or more wavelength bands, based on the first pixel values and second information” means that in the first process, the controller does not generate four or more second images corresponding one-to-one to four or more wavelength bands (i.e., the wavelength band W₁, . . . , and the wavelength band W_{w}), based on g1=(g1(1, 1) . . . g1(n, m))^{T} and H₂. That is, the controller does not calculate f₁₁ corresponding to the wavelength band W₁, . . . , and f_{1w} corresponding to the wavelength band W_{w}, based on expression (2) corresponding to the following expression.

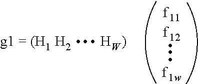

This makes it possible to reduce the amount of computation of the controller.

The sixth pixel values corresponding to the first wavelength band may be represented as n×m components included in a matrix f_{2R} of n×m rows and one column corresponding to the wavelength band W_{R}, the seventh pixel values corresponding to the second wavelength band may be represented as n×m components included in a matrix f_{2G} of n×m rows and one column corresponding to the wavelength band W_{G}, and the eighth pixel values corresponding to the third wavelength band may be represented as n×m components included in a matrix f_{2B} of n×m rows and one column corresponding to the wavelength band W_{B}.

Expression (1) can be expressed as follows.

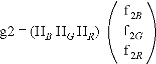

The third image may be a second RGB image generated based on f_{2R}, f_{2G}, and f_{2B}.

In modification A, “in the second process, the controller generates four or more fourth images corresponding one-to-one to the four or more wavelength bands, based on the second pixel values and the second information” means that in the second process, the controller generates four or more fourth images corresponding one-to-one to four or more wavelength bands (i.e., the wavelength band W₁, . . . , and the wavelength band W_{w}), based on g2=(g2(1, 1) . . . g2(n, m)) T and H₂. That is, the controller calculates f₂₁ corresponding to the wavelength band W₁, f₂₂, . . . , and f_{2w} corresponding to the wavelength band W_{w}, based on expression (2) corresponding to the following expression.

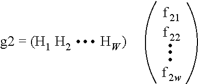

The controller generates an image I₂₁ corresponding to the wavelength band W₁ based on f₂₁, . . . , and an image I_{2w} corresponding to the wavelength band W_{w} based on f_{2w}.

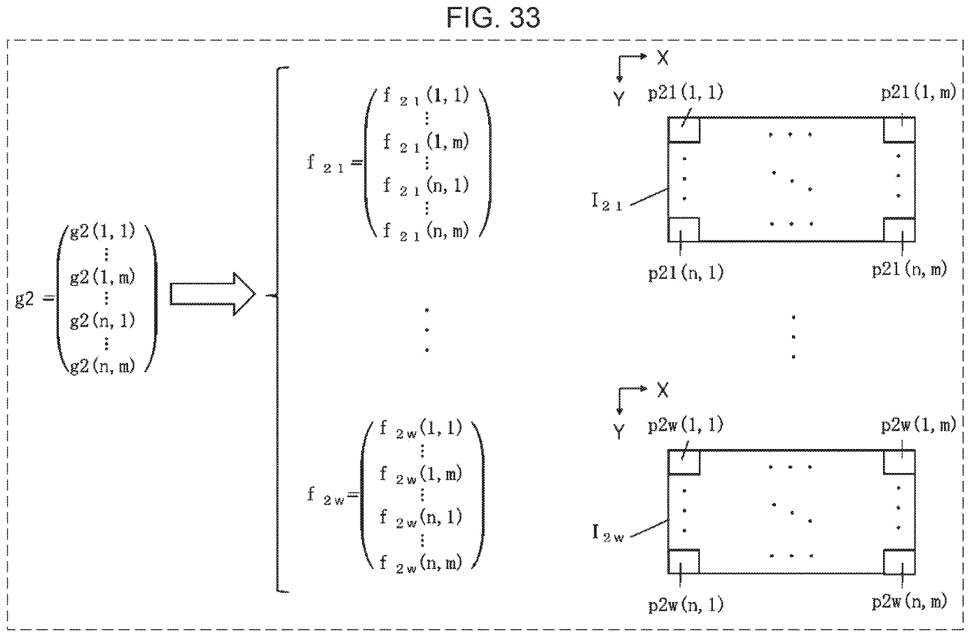

FIG. 33 is a diagram illustrating an example of the image I₂₁, . . . , and the image I_{2w}.

The image I₂₁ includes a pixel p₂₁(1, 1) having a pixel value f₂₁(1, 1), . . . , and a pixel p₂₁(n, m) having a pixel value f₂₁(n, m), and the Image I_{2w} includes a pixel p_{2w}(1, 1) having a pixel value f_{2w}(1, 1), . . . , and a pixel p_{2w}(n, m) having a pixel value f_{2w}(n, m).

The present disclosure can be applied to an image processing method for reconstructing an image and can be utilized in an image processing system, an imaging system, a camera system, an analysis system, a recognition system, and the like.

What is claimed is:

1. An image processing method comprising:
acquiring a compressed image;
switching between a viewing mode and a save mode;
in the viewing mode, displaying a first image on a display device and deleting the first image after displaying the first image, the first image being either the compressed image or a display-processed image that is generated based on the compressed image and represented by information of three or fewer wavelength bands; and
in the save mode, generating, based on the compressed image, a second image represented by information of four or more wavelength bands, and saving the second image to a recording medium.

2. The image processing method according to claim 1, wherein
the first image is the compressed image.

3. The image processing method according to claim 1, wherein
the first image is the display-processed image.

4. The image processing method according to claim 3, wherein
the first image is an RGB image represented by information of three wavelength bands.

5. The image processing method according to claim 3, wherein
the first image is a monochrome image represented by information of one wavelength band.

6. The image processing method according to claim 3, wherein
the first image has a lower resolution than the second image.

7. The image processing method according to claim 3, wherein
in acquisition of the compressed image, the compressed image is acquired through light receiving regions having transmission spectra,
in generation of the first image, the first image is generated based on the compressed image and first mask data that includes values reflecting the transmission spectra,
in generation of the second image, the second image is generated based on the compressed image and second mask data that includes values reflecting the transmission spectra, and
the values included in the first mask data are fewer than the values included in the second mask data.

8. The image processing method according to claim 1, wherein
the switching between the viewing mode and the save mode is performed based on an operation performed by a user.

9. The image processing method according to claim 1, further comprising:
in the viewing mode, determining whether the first image includes a specific subject, wherein
in the switching between the viewing mode and the save mode,
the viewing mode is continued in response to a determination being made that the first image does not include the specific subject, and
switching from the viewing mode to the save mode is performed in response to a determination being made that the first image includes the specific subject.

10. The image processing method according to claim 1, further comprising:
in the save mode, displaying the first image on the display device.

11. The image processing method according to claim 10, further comprising:
in the save mode, saving the first image to the recording medium.

12. The image processing method according to claim 10, further comprising:
in the save mode, displaying one or both of the second image and an analysis result of a subject based on the second image.

13. The image processing method according to claim 3, further comprising:
in the save mode, generating the first image, based on the second image generated based on the compressed image, and displaying the first image on the display device.

14. An image processing system comprising:
an image sensor that acquires a compressed image; and
a processing circuit that switches between a viewing mode and a save mode, wherein
in the viewing mode, the processing circuit displays a first image on a display device and deletes the first image after displaying the first image, the first image being either the compressed image or a display-processed image that is generated based on the compressed image and represented by information of three or fewer wavelength bands, and
in the save mode, the processing circuit generates, based on the compressed image, a second image represented by information of four or more wavelength bands, and saves the second image to a recording medium.

15. A non-transitory computer-readable recording medium storing a program that causes a computer to execute a process, the program causing the computer to execute the image processing method according to claim 1.
